(19) United States
(12) Patent Application Publication
(10) Pub. No.: US 2026/0239111 A1
(43) Pub. Date: Aug. 13, 2026

(54) CELL MEASUREMENT METHOD AND APPARATUS, DEVICE, AND STORAGE MEDIUM

(71) Applicant: Beijing Xiaomi Mobile Software Co., Ltd., Beijing (CN)

(72) Inventor: Yi XIONG, Beijing (CN)

(73) Assignee: Beijing Xiaomi Mobile Software Co., Ltd., Beijing (CN)

(21) Appl. No.: 19/155,728

(22) PCT Filed: Feb. 16, 2023
(86) PCT No.: PCT/CN2023/076598

§ 371 Date: Aug. 12, 2025

(51) Int. Cl. H04W 36/00; H04W 36/36; H04W 76/20

(52) U.S. Cl. CPC H04W 36/0016; H04W 36/0058; H04W 36/362; H04W 76/20

(57) ABSTRACT

Disclosed are a cell measurement method and apparatus, a device, and a storage medium, relating to the technical field of communication. The method is performed by a terminal. The method comprises: receiving a first message, the first message being used to configure first configuration information and second configuration information; and obtaining a first measurement result corresponding to the first configuration information, and/or obtaining a second measurement result corresponding to the second configuration information, wherein the first configuration information is used to carry a mobility configuration of a first candidate cell or a cell group, and the second configuration information is used to carry a mobility configuration of a second candidate cell or a cell group. According to the method, measurement results corresponding to two pieces of configuration information can be obtained when the two pieces of measurement configuration information are jointly configured.

### CROSS-REFERENCE TO RELATED APPLICATION

The application is a U.S. National Stage of International Application No. PCT/CN2023/076598, filed on Feb. 16, 2023, the entire content of which is incorporated herein by reference.

### TECHNICAL FIELD

Embodiments of the present disclosure relate to the communication technical field, and in particular to a cell measurement method and apparatus, a device, and storage medium.

### BACKGROUND

In the related art, mobility management based on conditional triggering is introduced. A terminal implements the mobility management based on conditional triggering based on condition(s) configured by a network and an associated candidate cell. When a measurement result meets the condition(s), the terminal triggers the mobility management and accesses a candidate cell associated with the measurement result.

### SUMMARY

Embodiments of the present disclosure provide a cell measurement method and apparatus, a device and a storage medium, which can obtain measurement results corresponding to two pieces of configuration information respectively in a case where configuration information for two kinds of measurements is jointly configured. The technical solutions are as follows:

According to an aspect of an embodiment of the present disclosure, a cell measurement method is provided. The method is performed by a terminal. The method includes: receiving a first message, where the first message is used to configure first configuration information and second configuration information; and
obtaining a first measurement result corresponding to the first configuration information, and/or obtaining a second measurement result corresponding to the second configuration information;
where the first configuration information is used to carry a mobility configuration for a first candidate cell or cell group, and the second configuration information is used to carry a mobility configuration for a second candidate cell or cell group.

According to another aspect of an embodiment of the present disclosure, a cell measurement method is provided. The method is performed by a network device. The method includes:
sending a first message, where the first message is used to configure first configuration information and second configuration information;
where the first configuration information is used to configure a mobility configuration for a first candidate cell or a cell group for the terminal, and the second configuration information is used to configure a mobility configuration for a second candidate cell or a cell group for the terminal.

According to another aspect of an embodiment of the present disclosure, a cell measurement method is provided. The method is performed by a communication system. The communication system includes a terminal and a network device. The method includes:
sending, by the network device, a first message, where the first message is used to configure first configuration information and second configuration information;
receiving, by the terminal, the first message; and
obtaining, by the terminal, a first measurement result corresponding to the first configuration information, and/or obtaining a second measurement result corresponding to the second configuration information;
where the first configuration information is used to carry a mobility configuration for a first candidate cell or cell group, and the second configuration information is used to carry a mobility configuration for a second candidate cell or cell group.

According to an aspect of an embodiment of the present disclosure, a cell measurement apparatus is provided. The apparatus includes:
a receiving module configured to receive a first message, where the first message is used to configure first configuration information and second configuration information; and
an obtaining module configured to obtain a first measurement result corresponding to the first configuration information, and/or obtain a second measurement result corresponding to the second configuration information;
where the first configuration information is used to carry a mobility configuration for a first candidate cell or cell group, and the second configuration information is used to carry a mobility configuration for a second candidate cell or cell group.

According to another aspect of an embodiment of the present disclosure, a cell measurement apparatus is provided. The apparatus includes:
a sending module configured to send a first message, where the first message is used to configure first configuration information and second configuration information;
where the first configuration information is used to configure a mobility configuration for a first candidate cell or a cell group for a terminal, and the second configuration information is used to configure a mobility configuration for a second candidate cell or a cell group for the terminal.

According to an aspect of an embodiment of the present disclosure, a terminal is provided. The terminal includes a transceiver and a processor;
the transceiver is configured to receive a first message, where the first message is used to configure first configuration information and second configuration information;
the processor is configured to obtain a first measurement result corresponding to the first configuration information, and/or obtain a second measurement result corresponding to the second configuration information;
where the first configuration information is used to carry a mobility configuration for a first candidate cell or cell group, and the second configuration information is used to carry a mobility configuration for a second candidate cell or cell group.

According to another aspect of an embodiment of the present disclosure, a network device is provided. The network device includes a transceiver;
where the transceiver is configured to send a first message, where the first message is used to configure first configuration information and second configuration information;
where the first configuration information is used to configure a mobility configuration for a first candidate cell or a cell group for a terminal, and the second configuration information is used to configure a mobility configuration for a second candidate cell or a cell group for the terminal.

According to another aspect of an embodiment of the present disclosure, a cell measurement system is provided. The system includes:
a network device configured to perform the method performed by the network device in the above-described cell measurement method;
a terminal configured to perform the method executed by the terminal in the above-described cell measurement method.

According to an aspect of an embodiment of the present disclosure, a computer-readable storage medium is provided. A computer program is stored in the storage medium. The computer program is used to be executed by a processor to implement the above-described cell measurement method.

According to an aspect of an embodiment of the present disclosure, a chip is provided. The chip includes a programmable logic circuit and/or program instructions. When the chip is run, the above-described cell measurement method is implemented.

According to an aspect of an embodiment of the present disclosure, a computer program product or a computer program is provided. The computer program product or the computer program includes computer instructions. The computer instructions are stored in a computer-readable storage medium, and a processor reads and executes the computer instructions from the computer-readable storage medium to implement the above-described cell measurement method.

### BRIEF DESCRIPTION OF THE DRAWINGS

In order to more clearly illustrate the technical solutions in the embodiments of the present disclosure, the drawings required for use in the description of the embodiments will be briefly introduced below. Obviously, the drawings described below are only some embodiments of the present disclosure. For those of ordinary skill in this art, other drawings can be obtained based on these drawings without paying any creative work.

FIG. 1 is a schematic diagram of a communication system provided by an example embodiment of the present disclosure;

FIG. 2 is a schematic diagram of a communication system provided by an example embodiment of the present disclosure;

FIG. 3 is a schematic diagram of a communication system provided by an example embodiment of the present disclosure;

FIG. 4 is a schematic diagram of a communication system provided by an example embodiment of the present disclosure;

FIG. 5a is a flowchart of a cell measurement method provided by an example embodiment of the present disclosure;

FIG. 5b is a flowchart of a cell measurement method provided by an example embodiment of the present disclosure;

FIG. 6 is a flowchart of a cell measurement method provided by an example embodiment of the present disclosure;

FIG. 7a is a flowchart of a cell measurement method provided by an example embodiment of the present disclosure;

FIG. 7b is a flowchart of a cell measurement method provided by an example embodiment of the present disclosure;

FIG. 8a is a flowchart of a cell measurement method provided by an example embodiment of the present disclosure;

FIG. 8b is a flowchart of a cell measurement method provided by an example embodiment of the present disclosure;

FIG. 8c is a flowchart of a cell measurement method provided by an example embodiment of the present disclosure;

FIG. 9 is a flowchart of a cell measurement method provided by an example embodiment of the present disclosure;

FIG. 10a is a flowchart of a cell measurement method provided by an example embodiment of the present disclosure;

FIG. 10b is a flowchart of a cell measurement method provided by an example embodiment of the present disclosure;

FIG. 11 is a flowchart of a cell measurement method provided by an example embodiment of the present disclosure;

FIG. 12 is a flowchart of a cell measurement method provided by an example embodiment of the present disclosure;

FIG. 13 is a block diagram of a cell measurement apparatus provided by an example embodiment of the present disclosure;

FIG. 14 is a block diagram of a cell measurement apparatus provided by an example embodiment of the present disclosure; and

FIG. 15 is a schematic diagram of a structure of a communication device provided by an example embodiment of the present disclosure.

### DETAILED DESCRIPTION

In order to make the objectives, technical solutions and advantages of the present disclosure clearer, implementations of the present disclosure will be further described in detail below with reference to the accompanying drawings.

The network architectures and service scenarios described in the embodiments of the present disclosure are intended to more clearly illustrate the technical solutions of the embodiments of the present disclosure, and do not constitute a limitation on the technical solutions provided by the embodiments of the present disclosure. Those of ordinary skill in this art can appreciate that with the evolution of network architectures and the emergence of new service scenarios, the technical solutions provided by the embodiments of the present disclosure can also be applicable to similar technical problems.

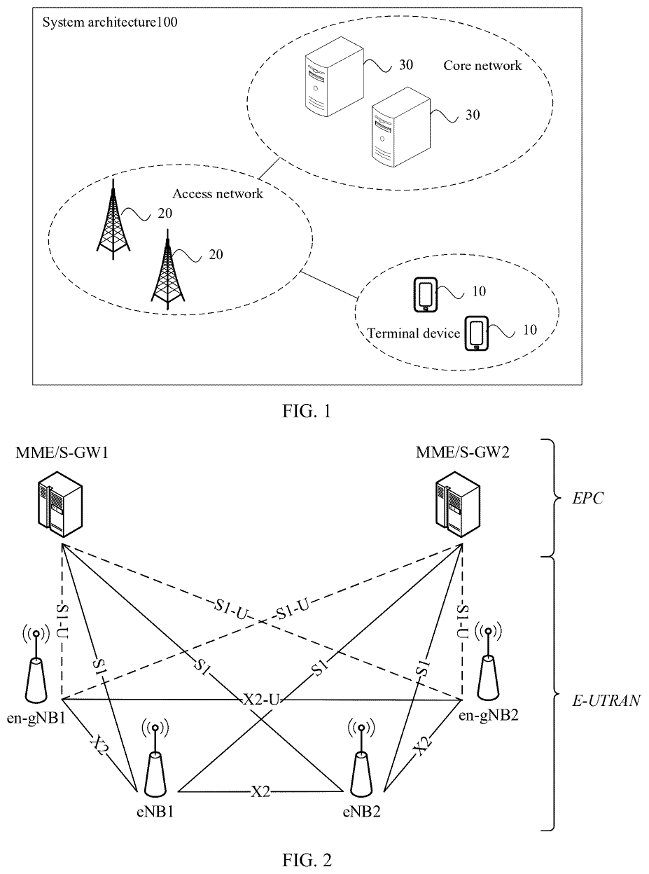

Referring to FIG. 1, a schematic diagram of a system architecture provided by an embodiment of the present application is shown. The system architecture 100 may include: a terminal 10, an access network device 20, and a core network device 30.

The terminal 10 may refer to User Equipment (UE), an access terminal, a user unit, a user station, a mobile station, a mobile, a remote station, a remote terminal, a mobile device, a wireless terminal, a user agent or a user device. Optionally, the terminal 10 may also be a cellular phone, a cordless phone, a Session Initiation Protocol (SIP) phone, a Wireless Local Loop (WLL) station, a Personal Digital Assistant (PDA), a handheld device with a wireless communication function, a computing device or other processing device connected to a wireless modem, a vehicle-mounted device, a wearable device, a terminal in a 5th Generation System (5GS) or a terminal in a future evolved Public Land Mobile Network (PLMN), etc., which is not limited in the embodiments of the present application. For the convenience of description, the above-mentioned devices are collectively referred to as a terminal. There are usually multiple terminals 10, and one or more terminals 10 may be distributed in a cell managed by each access network device 20.

The access network device 20 is a device deployed in an access network to provide wireless communication functions for terminal(s) 10. The access network device 20 may include various forms of devices, such as a macro base station, a micro base station, a relay station, an access point, etc. In systems using different radio access technologies, the name of the device with access network device functions may be different. For example, in the 5G NR system, the device is called a gNodeB or gNB. With the evolution of communication technologies, the name “access network device” may change. For the convenience of description, in the embodiments of the present application, the above-mentioned apparatuses that provide wireless communication functions for the terminal(s) 10 are collectively referred to as an access network device. Optionally, a communication relationship may be established between the terminal(s) 10 and the core network device 30 through the access network device 20. For example, in an LTE system, the access network device 20 may be Evolved Universal Mobile Telecommunications System Terrestrial Radio Access Network (E-UTRAN) or one or more eNodeBs in the E-UTRAN. In the 5G NR system, the access network device 20 may be Radio Access Network (RAN) or one or more gNBs in the RAN.

The access network device in the 3G communication system may be called a NodeB (NB). The access network device in the 4G communication system may be called an eNodeB (evolved NodeB, eNB). Under the Non-Standalone (NSA) architecture of the Option 4 series, the 4G access network device needs to be upgraded to support eLTE and connect to the 5G core network. The upgraded 4G access network device is called a ng-eNB. The access network device in the 5G communication system is called a gNB (generation NodeB). In the NAS Option 3 series, since the 5G access network device needs to access the 4G core network, the 5G gNB needs to be modified to access the 4G core network. The modified gNB is called an en-gNB.

The functions of the core network device 30 are mainly to provide user connection, user management and service bearing, and to provide an interface to an external network as a bearer network. For example, the core network device in the 5G New Radio (NR) system may include devices such as an Access and Mobility Management Function (AMF) entity, a User Plane Function (UPF) entity and a Session Management Function (SMF) entity, etc.

In an example, the access network device 20 and the core network device 30 communicate with each other through certain air technology, such as the NG interface in the 5G NR system. The access network device 20 and the terminal(s) 10 communicate with each other through certain air technology, such as the Uu interface.

The technical solutions provided in the embodiments of the present disclosure may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, a LTE Frequency Division Duplex (FDD) system, a LTE Time Division Duplex (TDD) system, an Advanced Long Term Evolution (LTE-A) system, a Universal Mobile Telecommunication System (UMTS), a Worldwide Interoperability for Microwave Access (WiMAX) communication system, a 5th Generation (5G) mobile communication system, a New Radio (NR) system, an evolved system of the NR system, a LTE-based access to unlicensed spectrum (LTE-U) system, a NR-based access to unlicensed spectrum (NR-U) system, a Terrestrial Networks (TN) system, a Non-Terrestrial Networks (NTN) system, Wireless Local Area Networks (WLAN), Wireless Fidelity (Wi-Fi), a cellular Internet of Things system, or a cellular passive Internet of Things system. The technical solutions provided in the embodiments of the present disclosure may also be applied to a subsequent evolved system of the 5G NR system, or may also be applied to Beyond Fifth Generation (B5G), 6G, and a subsequent evolved system. In some embodiments of the present disclosure, “NR” may also be referred to as a 5G NR system or a 5G system. The 5G mobile communication system may include Non-Standalone (NSA) networking and/or Standalone (SA) networking.

In addition, in the embodiments of the present disclosure, the terms “network” and “system” are often used interchangeably, but those of ordinary skill in this art can understand their meanings.

First, some background technical knowledge involved in the present application is introduced and explained. The following related technologies may be combined arbitrarily with the technical solutions of the embodiments of the present application as optional solutions, and they all belong to the protection scope of the embodiments of the present application. The embodiments of the present application include at least part of the following contents.

### I. Dual Connectivity

### 1. MR-DC (Multi-Radio Dual Connectivity)

MR-DC is a generalized Intra Evolved Universal Mobile Telecommunications System Terrestrial Radio Access (Intra-E-UTRA) dual connectivity, where a UE may utilize radio resources provided by two distinct schedulers located in two different Next Generation Radio Access Network (NG-RAN) nodes connected via a non-ideal backhaul. One scheduler provides NR access and the other scheduler provides Evolved UMTS Terrestrial Radio Access (E-UTRA) or NR access. One scheduler acts as a Master Node (MN) and the other scheduler acts as a Secondary Node (SN). The MN and SN are connected through a network interface, and at least one MN is connected to a core network.

2. MR-DC with EPC (Evolved Packet Core, 4G Core Network)

The Evolved UMTS Terrestrial Radio Access Network (E-UTRAN) supports MR-DC through E-UTRA-NR DC (E-UTRA-NR Dual Connectivity, also known as EN-DC), where a UE is connected to an eNB acting as an MN and an en-gNB acting as an SN. The eNB is connected to the EPC through an S1 interface and to the en-gNB through a X2 interface. The en-gNB is connected to the EPC through a S1-U interface and to other en-gNBs through a X2-U interface.

For example, the EN-DC architecture is shown in FIG. 2. An en-gNB1 is connected to Mobility Management Entity/Serving GateWay 1 (MME/S-GW1) and MME/S-GW2 through an S1-U interface. An en-gNB2 is connected to MME/S-GW1 and MME/S-GW2 through an S1-U interface. The en-gNB1 is connected to the en-gNB2 through an X2-U interface. The eNB1 is connected to MME/S-GW1 and MME/S-GW2 through an S1 interface. The eNB2 is connected to MME/S-GW1 and MME/S-GW2 through an S1 interface. The eNB1 is connected to eNB2 through an X2 interface. The MME/S-GW1 and MME/S-GW2 belong to EPC, and the en-gNB1, the en-gNB2, the eNB1 and the eNB2 belong to E-UTRAN.

3. MR-DC with 5GC (5th Generation Core)

### A: E-UTRA-NR DC (E-UTRA-NR Dual Connectivity, Also Known as NGEN-DC).

The NG-RAN supports NG-RAN E-UTRA-NR Dual Connectivity (also known as NGEN-DC), where a UE is connected to an ng-eNB acting as an MN and a gNB acting as an SN. The ng-eNB is connected to the 5GC, and the gNB is connected to the ng-eNB through an Xn interface.

### B: NR-E-UTRA DC (NR-E-UTRA Dual Connectivity, Also Known as NE-DC).

The NG-RAN supports NR-E-UTRA DC, where a UE is connected to a gNB acting as an MN and an ng-eNB acting as an SN. The gNB is connected to the 5GC, and the ng-eNB is connected to the gNB through the Xn interface.

### C: NR-NR Dual Connectivity (Also Known as NR DC)

The NG-RAN supports NR-NR DC, where a UE is connected to a gNB acting as an MN and another gNB acting as an SN. The gNB (also called a primary gNB) acting as the MN is connected to the 5GC through a NG interface, and the two gNBs are connected via the Xn interface. The gNB (also called a secondary gNB) acting as the SN may also be connected to the 5GC through a NG-U interface. In addition, in NR-DC, the UE may also access a single gNB, which acts as both an MN and an SN, and the gNB is configured with both a Master Cell Group (MCG) and a Secondary Cell Group (SCG).

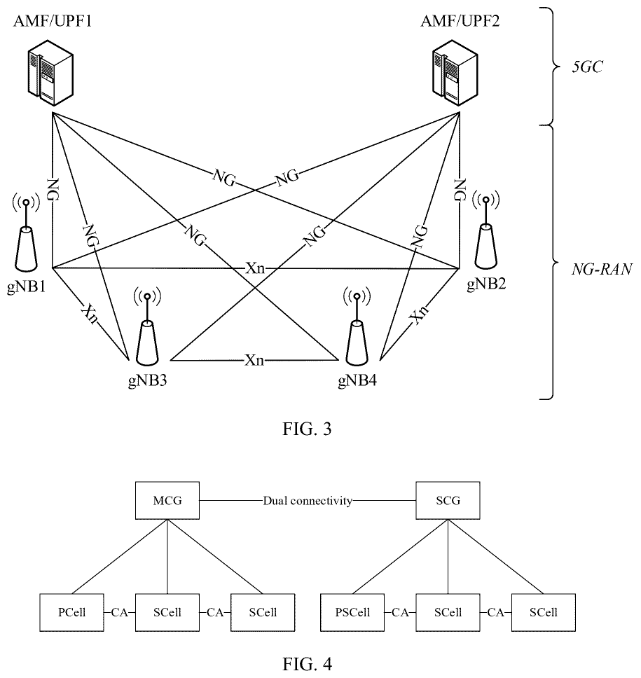

For example, the NR-DC architecture is shown in FIG. 3. A gNB1 acting as an MN is connected to a gNB2 acting as an SN through an Xn interface, the gNB1 is connected to AMF/UPF1 and AMF/UPF2 through an NG-U interface, and the gNB2 is connected to AMF/UPF1 and AMF/UPF2 through an NG-U interface. The gNB1 is connected to the gNB3 through an Xn interface. The gNB2 is connected to the gNB4 through an Xn interface. The gNB3 is connected to the gNB4 through an Xn interface. The AMF/UPF1 and AMF/UPF2 belong to 5GC, and the gNB1, the gNB2, the gNB3 and the gNB4 belong to NG-RAN.

In dual connectivity, a UE may access two cell groups, namely an MCG and an SCG. In an MCG, there may be many cells, one of which is used to initiate initial access, and this cell is called Primary Cell (PCell). As the name suggests, the PCell is the most “primary” cell in the MCG. The primary cell in the MCG is called PCell, and a secondary cell is called SCell (Secondary Cell). The primary cell in the SCG is called Primary Secondary Cell (PSCell), and the secondary cell is called SCell. The PCell in the MCG and the SCell in the MCG are combined through Carrier Aggregation (CA). Because many pieces of signaling are only sent on PCell and PSCell, for the convenience of description, PCell and PSCell may also be collectively referred to as special Cell (sPCell).

For example, as shown in FIG. 4, in dual connectivity, a UE may access two cell groups, namely an MCG and an SCG. The MCG includes a PCell, a SCell1 and a SCell2, and the SCG includes a PSCell, a SCell3 and a SCell4. In the MCG, the PCell and the SCell1, and the SCell1 and the SCell2 are combined together through CA; in the SCG, the PSCell and the SCell3, and the SCell3 and the SCell4 are combined together through CA.

### II. Selective Activation of Cell Groups

In related art, for Conditional Handover (CHO), Conditional PSCell Addition/Conditional PSCell Change (CPA/CPC) (CPA and CPC may also be collectively referred to as CPAC), a UE with CHO/CPA/CPC configuration(s) releases the CHO/CPA/CPC configuration(s) when completing random access to a target PCell/PSCell. If a network device does not reconfigure and initialize CHO/CPA/CPC for the UE, UE will no longer have the opportunity to continue to execute CHO/CPA/CPC. Therefore, the network device needs to reconfigure and initialize CHO/CPA/CPC for the UE, which will increase the delay of conditional handover or SCG change and increase the signal transmission overhead. Especially in a Frequency Range 2 (FR2) scenario, this problem is more prominent when the Common Gateway (CG) is frequently changed.

Thus, selective activation of cell groups in MR-DC is proposed in related art, which can ensure that after CG change, the subsequent configuration for selective activation of cell groups can still be executed without the need for the network device to reconfigure or initialize the corresponding configuration for selective activation of cell groups for the UE. This can reduce signaling overhead and the interruption duration of CG change.

The configuration for selective activation of cell groups may include at least one of: a configuration ID, an activation condition, a configuration for a cell or cell group to be activated.

In the selective activation of cell groups, the network device may provide a terminal with a “cell group to be activated”. The terminal may subsequently activate or deactivate the “cell group to be activated” without the need for the network device to re-provide the configuration for the cell group.

That is, in the selective activation of cell groups, after activating a new cell group configuration, the UE will not delete the configuration for the selective activation of the cell groups.

Currently, the selective activation of SCG is being studied in related art to enable a terminal device to continue a subsequent CPC procedure after SCG change or addition without a Radio Resource Control (RRC) reconfiguration message.

In the related art, the selective activation of cell groups in MR-DC can enable configuration(s) to be subsequently executed after Cell Group (CG) change, without the need for the network to reconfigure or reinitialize corresponding configuration information for selective activation of cell groups, thereby reducing signaling overhead and the interruption duration of the cell group change.

As an example, in the selective activation of cell groups, a network device may provide the terminal with pre-configured candidate target cell group(s) or target cell(s). The terminal may subsequently activate or deactivate a pre-configured candidate cell or cell group according to a configuration (e.g., an activation message) sent by the network device or a corresponding activation event, without the need of re-providing the configuration for the cell group. Alternatively, in the selective activation of cell groups, after activating a new cell or cell group, or applying a new cell configuration or cell group configuration, or accessing a new cell or cell group, the UE will not delete corresponding configuration information for the selective activation of cell groups.

As an example, the selective activation of cell groups may also be referred to as cell group activation. Cell group activation enables corresponding configuration information to be executed after cell and/or cell group change, without the need for the network to reconfigure or reinitialize the corresponding configuration information for cell group activation. Therefore, selective activation of cell groups can reduce signaling overhead and the interruption duration of a cell group change. The configuration information for cell group activation may include: a configuration ID and configuration(s) of target cell(s) or configuration(s) of target cell group(s). Optionally, the configuration information for cell group activation may also include a trigger condition (or referred to as an execution condition, an activation condition).

As an example, the selective activation of cell groups is a mobility management procedure, including any kind of mobility management procedure in which a UE activates or deactivates a corresponding cell or cell group, or applies a corresponding cell configuration or cell group configuration or accesses the cell or cell group, according to signaling sent by the network side, a principle specified in a specification, or a UE autonomous mode, etc.

As an example, the selective activation of cell groups is a mobility management procedure, including any kind of mobility management procedure in which after the mobility procedure is executed, deletion or release of a corresponding part or all of configuration information is not performed. Not deleting or releasing the corresponding part or all of the configuration information may also be called retaining the corresponding part or all of the configuration information.

### 3. LTM (L1/L2-Triggered Mobility)

In the 5G system, a network device may provide multiple “candidate cells (or candidate cell groups)” to a terminal. The network device may subsequently control the terminal device to change among multiple “candidate cells (or candidate cell groups)” (for example, changing the working cell (or cell group) from “candidate cell-1 (or candidate cell group-1)” to “candidate cell-2 (or candidate cell group-2)”) through L1 signaling (such as Downlink Control Information (DCI)) or L2 signaling (such as MAC CE (Control Element)). One serving cell (or cell group) may correspond to one or more “candidate cells (or candidate cell groups)”.

### 4. Conditional Reconfiguration

ConditionalReconfiguration (a conditional reconfiguration) is used to configure, modify, or release configuration information of a conditional reconfiguration.

The ConditionalReconfiguration includes condReconfigToAddModList (a conditional reconfirmation addition or modification list), condReconfigToRemoveList (a conditional reconfirmation removal list) and attemptCondReconfig (an attempt conditional reconfirmation).

The condReconfigToRemoveList includes CondReconfigId (a configuration identity or a conditional reconfiguration identity), and the CondReconfigToAddMod corresponds to configuration information of a conditional reconfiguration.

The CondReconfigToAddModList includes a list of conditional reconfigurations to add or modify, with for each entry the condReconfigId (a configuration identity or a conditional reconfiguration identity) and the associated condExecutionCond (a first execution condition or a second execution condition)/condExecutionCondSCG (a first execution condition or a second execution condition) and condRRCReconfig (a conditional RRC reconfiguration).

The CondReconfigToAddModList includes one or more CondReconfigToAddMod, where each CondReconfigToAddMod includes condReconfigId, condExecutionCond, and condRRCReconfig, and condRRCReconfig includes CondReconfigExecCondSCG (a conditional reconfiguration execution condition SCG).

### 1. CHO

CHO refers to a handover performed by a UE when one or more handover execution conditions are met. The UE starts evaluating the execution condition(s) after receiving the CHO configuration and stops evaluating the execution condition(s) after performing the handover (including legacy handover and CHO). The following principles apply to CHO:
(1) A CHO configuration includes a configuration of CHO candidate cell(s) and first execution condition(s).
(2) A first execution condition may include one or two trigger conditions (conditional event A3/A5)
a: CondEvent A3: Conditional reconfiguration candidate becomes amount of offset better than PCell/PSCell.
b: CondEvent A5: PCell/PSCell becomes worse than absolute threshold1 AND Conditional reconfiguration candidate becomes better than another absolute threshold2.
(3) Before any CHO execution condition is met, upon reception of a handover command (without a CHO configuration) by a UE, a legacy HO procedure is executed regardless of any previously received CHO configuration.
(4) While executing CHO, that is, from the time the UE starts to synchronize with a target cell, the UE no longer monitors the original cell.

### 2. CPA

A Conditional PSCell Addition (CPA) is defined as a PSCell addition that is executed by the UE when execution condition(s) is met. The UE starts evaluating the execution condition(s) upon receiving the CPA configuration, and stops evaluating the execution condition(s) once PSCell addition or PCell change is triggered.

The trigger condition for CPA may be CondEvent A4.

CondEvent A4: Conditional reconfiguration candidate becomes better than absolute threshold.

### 3. CPC

A Conditional PSCell Change (CPC) is defined as a PSCell change that is executed by the UE when execution condition(s) is met. The UE starts evaluating the execution condition(s) upon receiving the CPC configuration, and stops evaluating the execution condition(s) once PSCell change or PCell change is triggered. Intra-SN CPC without MN involvement, inter-SN CPC initiated either by MN or SN are supported.

The trigger condition for the CPC initiated by the MN may be CondEvent A4.

CondEvent A4: Conditional reconfiguration candidate becomes better than absolute threshold.

The trigger condition for the CPC initiated by the SN may be CondEvent A3/A5.

CondEvent A3: Conditional reconfiguration candidate becomes amount of offset better than PCell/PSCell.

CondEvent A5: PCell/PSCell becomes worse than absolute threshold1 AND

Conditional reconfiguration candidate becomes better than another absolute threshold2.

### 4. CHO and CPAC Joint Configuration

In related art, mobility management based on conditional triggering is introduced, in which a UE implements mobility management based on conditional triggering based on the condition(s) configured by the network and the associated candidate cell(s). After the condition(s) is (are) met, the UE triggers mobility management and accesses its associated candidate cell(s). The condition(s) configured by the network may be specific event(s) based on measurement result(s), or may be location-based or time-based event(s). The associated candidate cell(s) may be a candidate primary cell and a primary secondary cell, corresponding to the corresponding mobility management (CHO and CPC/CPA) based on conditional triggering, respectively. In current related art, MN-initiated CHO, MN-initiated CPA/CPC and SN-initiated CPC are supported.

However, current related art does not support configure CHO and CPA/CPC at the same time. In order to improve robustness and reduce the impact on UE throughput, a solution combining CHO and CPC/CPA is proposed in related art, and it is decided to include a target MCG and a candidate SCG for CPC/CPA in CHO. A UE with joint configuration of CHO and CPA/CPC can execute CHO and its corresponding CPA/CPC at the same time.

The joint configuration of CHO and CPAC may be including a CPAC configuration in a CHO configuration, i.e., nested configuration. The configuration of CHO and its one or more associated CPACs is included in configuration information of a conditional reconfiguration (a first ConditionalReconfiguration). The configuration information for one or more CPACs (a second conditionalReconfiguration) is included in the configuration information for CHO (CondReconfigToAddMod), and the configuration information for CHO (CondReconfigToAddMod) includes:
a first configuration identity (a first condReconfigId), a first execution condition corresponding to CHO (a first condExecutionCond), and a first conditional RRC reconfiguration (a first condRRCReconfig). The first conditional RRC reconfiguration includes a first RRC reconfiguration message (a first RRCReconfiguration message). The first RRC reconfiguration message includes configuration information for one or more CPACs (a second conditionalReconfiguration). The first RRC reconfiguration message further includes configuration information for CHO. That is, the first RRC reconfiguration message includes both the configuration information for candidate PCell/MCG and configuration information for candidate PSCell/SCG.

The execution conditions for CHO and CPAC may be represented by one or more measurement identities. One measurement identity can be associated with one trigger event.

Referring to FIG. 5a, a flowchart of a cell measurement method provided by an embodiment of the present disclosure is shown. The embodiment is illustrated by taking an example in which the method is applied to a terminal in the communication system shown in FIG. 1. The method may include the following steps.

In step 200, a first message is received. The first message is used to configure first configuration information and second configuration information.

For example, the first message is ConditionalReconfiguration (a conditional reconfiguration message). For example, the first message may be at least one of: a condReconfigToAddModList (a conditional reconfiguration addition or modification list) message, a condReconfigToRemoveList (a conditional reconfiguration removal list) message, or an attemptCondReconfig (an attempt conditional reconfiguration) message.

When the first message is the conditional reconfiguration addition or modification list message, the first message is used to add or modify the first configuration information and/or the second configuration information stored in the terminal. When the first message is the conditional reconfiguration removal list message, the first message is used to remove the first configuration information and/or the second configuration information stored in the terminal.

For example, the first message is used to configure the first configuration information and/or the second configuration information.

For example, the first message is used to configure the first configuration information, and the first configuration information includes the second configuration information (for example, a first conditional RRC reconfiguration field of the first configuration information carries the second configuration information).

For another example, the first message is used to configure the first configuration information. Alternatively, the first message is used to configure the second configuration information.

For another example, the first configuration information is first configured through a second message (the second message may be a message of the same type as the first message). Subsequently, the first configuration information is modified through the first message, and the second configuration information is added to the first configuration information. For example, the terminal receives the second message, stores the first configuration information configured in the second message into a variable conditional reconfiguration (VarConditionalReconfig), and then the terminal receives the first message, in which the first configuration information is modified. For example, the second configuration information is added to the first conditional RRC reconfiguration field of the first configuration information, and the terminal adds the second configuration information to the first conditional RRC reconfiguration field of the first configuration information in the variable conditional reconfiguration (VarConditionalReconfig) according to the second message.

For example, the first configuration information and the second configuration information are used to carry a mobility configuration for a candidate cell or cell group. The first configuration information and the second configuration information respectively include a complete set of configuration information for mobility of the candidate cell or cell group. For example, the first configuration information includes: configuration information for mobility of a candidate cell or cell group, and the second configuration information. The second configuration information includes: configuration information for mobility of a second candidate cell or cell group. The configuration information for the mobility of the first candidate cell or cell group includes a first measurement identity, and the configuration information for the mobility of the second candidate cell or cell group includes a second measurement identity. The configuration information for the mobility of the first or second candidate cell or cell group may include at least one of: a configuration identity, an execution condition (measurement identity), or configuration information for the candidate cell or cell group.

Alternatively, the first configuration information or the second configuration information is used to carry a mobility configuration for a candidate PCell or MCG or PSCell or SCG. Alternatively, the first configuration information or the second configuration information is used to carry configuration information for CHO or CPC or CPA.

In an optional embodiment, the second configuration information is nested in the first configuration information, and the first configuration information includes the second configuration information in addition to the configuration information for the mobility of the first candidate cell or cell group. The second configuration information may be further nested in the configuration information for the mobility of the first candidate cell or cell group. For example, the first configuration information includes: a first configuration identity, a first execution condition, and a first conditional RRC reconfiguration, and the first conditional RRC reconfiguration includes the second configuration information and the configuration information for the first candidate cell or cell group.

Optionally, at least one field in the first configuration information carries the second configuration information. For example, a first field in the first configuration information carries the second configuration information. The first field may be a field dedicated to carrying the second configuration information, or the first field may be a field shared by the second configuration information and other information (for example, configuration information for a candidate cell or a cell group).

For example, the first configuration information includes at least one of the following field(s): a first configuration identity, a first execution condition, or a first conditional RRC reconfiguration.

The first configuration identity field is used to carry information of the first configuration identity. The first execution condition field is used to carry information of the first execution condition. The first conditional RRC reconfiguration field is used to carry configuration information for the first candidate cell or cell group and the second configuration information. The information of the first execution condition may be indicated by a first measurement identity. That is, the first execution condition field is used to carry the first measurement identity, and the terminal reads an execution condition corresponding to the first measurement identity from the local according to the first measurement identity.

For example, the second configuration information includes at least one of the following field(s): a second configuration identity, a second execution condition, or a second conditional RRC reconfiguration.

The second configuration identity field is used to carry information of the second configuration identity. The second execution condition field is used to carry information of the second execution condition. The second conditional RRC reconfiguration field is used to carry configuration information for the second candidate cell or cell group. The information of the second execution condition may be indicated by a second measurement identity. That is, the second execution condition field is used to carry the second measurement identity, and the terminal reads an execution condition corresponding to the second measurement identity from the local according to the second measurement identity.

In another optional embodiment, the first configuration information and the second configuration information are configured in association. For example, the first configuration information and the second configuration information configured simultaneously in the first message have an association relationship, and the terminal stores the first configuration information and the second configuration information in association with the variable conditional reconfiguration (VarConditionalReconfig). For example, the first configuration identity in the first configuration information and the second configuration identity in the second configuration information are stored in association.

For example, the first configuration information may be first conditional reconfiguration configuration information or configuration information of the first conditional reconfiguration, and the second configuration information may be second conditional reconfiguration configuration information or configuration information of the second conditional reconfiguration. The first configuration information is used to configure a mobility of an MCG, and the second configuration information is used to configure a mobility of an SCG.

In a possible embodiment, the terminal receives first conditional reconfiguration configuration information sent by the network side. The first conditional reconfiguration configuration information is used to configure the mobility of the MCG and the mobility of the SCG. The SCG is associated with the MCG. For example, the first conditional reconfiguration configuration information is used to configure configuration information for CHO and CPA or CPC.

For example, the first conditional reconfiguration configuration information includes one or more pieces of second conditional reconfiguration configuration information. The second conditional reconfiguration configuration information is used to configure the mobility of the SCG.

In a possible implementation, the first conditional reconfiguration configuration information includes a first configuration identity (condReconfigld), a first execution condition (condExecutionCond) corresponding to MCG mobility (CHO), and a first RRCReconfiguration message (a first condRRCReconfig, a first conditional RRC reconfiguration) that needs to be applied when the first execution condition is met.

In a possible implementation, the first RRCReconfiguration (an RRC reconfiguration) message includes one or more pieces of second conditional reconfiguration configuration information. The first RRCReconfiguration message further includes configuration information for a candidate MCG.

In a possible implementation, the second conditional reconfiguration configuration information includes a second configuration identity, a second execution condition (condExecutionCond or condExecutionCondSCG) corresponding to the SCG mobility (CPA or CPC), and a second RRCReconfiguration message (a second condRRCReconfig) that needs to be applied when the first execution condition is met. The second RRCReconfiguration message further includes configuration information for a candidate SCG.

In a possible implementation, the first execution condition or the second execution condition may be represented by one or more measurement identities.

In a possible embodiment, in response to receiving one or more pieces of first conditional reconfiguration configuration information, the UE stores the configuration information, and stores the configuration information in VarConditionalReconfig (a variable conditional reconfiguration) for storing conditional reconfiguration configuration(s).

In step 210, a first measurement result corresponding to the first configuration information is obtained, and/or a second measurement result corresponding to the second configuration information is obtained. The first configuration information is used to carry the mobility configuration for the first candidate cell or cell group, and the second configuration information is used to carry the mobility configuration for the second candidate cell or cell group.

Optionally, the terminal obtains the first measurement result corresponding to the first measurement identity based on the first measurement identity in the first configuration information; and the terminal obtains the second measurement result corresponding to the second measurement identity based on the second measurement identity in the second configuration information.

Alternatively, in a case where the first configuration information includes the second configuration information (the second configuration information is nested in the first configuration information, or the first configuration information has at least one field carrying the second configuration information), the terminal obtains the first measurement result corresponding to the first measurement identity based on the first measurement identity in the first configuration information; and the terminal obtains the second measurement result corresponding to the second measurement identity based on the second measurement identity in the second configuration information.

For example, when a measurement result of the first candidate cell or cell group (the first measurement result corresponding to the first measurement identity) meets the first execution condition, the terminal needs to apply the configuration information for the first candidate cell or cell group and determines to access the first candidate cell or cell group; when the measurement result of the second candidate cell or cell group (the second measurement result corresponding to the second measurement identity) meets the second execution condition, the terminal needs to apply the configuration information for the second candidate cell or cell group and determines to access the second candidate cell or cell group.

For example, the terminal stores a variable conditional reconfiguration (VarConditionalReconfig). The variable conditional reconfiguration stores: association relationship(s) between measurement identity (identities), measurement object(s), and report configuration(s) (reportConfig). The terminal obtains a measurement result of a measurement object corresponding to the first measurement identity according to the first measurement identity in the first configuration information, and the measurement object is the first candidate cell or cell group in the first configuration information. The terminal obtains a measurement result of a measurement object corresponding to the second measurement identity according to the second measurement identity in the second configuration information, and the measurement object is the second candidate cell or cell group in the second configuration information.

Optionally, the first measurement result is a measurement result of a first measurement object (the first candidate cell or cell group in the first configuration information) corresponding to the first measurement identity. The second measurement result is a measurement result of a second measurement object (the second candidate cell or cell group in the second configuration information) corresponding to the second measurement identity.

Optionally, when the terminal has performed measurement and obtained a measurement result, the terminal directly obtains the measurement result (the first measurement result or the second measurement result) according to the measurement identity (the first measurement identity or the second measurement identity). When the terminal has not performed measurement or has not stored a measurement result, the terminal starts measurement according to the measurement identity (the first measurement identity or the second measurement identity) and obtains the measurement result (the first measurement result or the second measurement result).

For example, obtaining the measurement result may further include starting a measurement. That is, the terminal starts the measurement and obtains the measurement result.

In an optional embodiment, the terminal may obtain the second measurement result according to the second measurement identity while obtaining the first measurement result according to the first measurement identity. Alternatively, the terminal may obtain the second measurement result according to the second measurement identity after obtaining the first measurement result according to the first measurement identity and before executing CHO. That is, the terminal first obtains the two measurement results, and then evaluates whether the execution conditions are met according to the two measurement results. Alternatively, the terminal may also first obtain the second measurement result according to the second measurement identity, and then obtain the first measurement result according to the first measurement identity.

For example, the terminal first obtains two measurement results according to two measurement identities, and then determines whether the two measurement results meet the execution conditions. The execution conditions are used to determine whether to access a corresponding candidate cell or cell group. For example, the first execution condition is used to determine whether to access the first candidate cell or cell group. If the first measurement result meets the first execution condition, the terminal determines to access the first candidate cell or cell group, and the terminal may subsequently perform the access procedure to access the first candidate cell or cell group. The second execution condition is used to determine whether to access the second candidate cell or cell group. If the second measurement result meets the second execution condition, the terminal determines to access the second candidate cell or cell group, and the terminal may subsequently perform the access procedure to access the second candidate cell or cell group. That is, the execution conditions are condition used to measure the measurement results after the measurements are performed to obtain the measurement results. The terminal may access a candidate cell or cell group corresponding to a measurement result if the measurement result is better (an execution condition is met).

For example, the first candidate cell or cell group in the first configuration information has an association relationship with the second candidate cell or cell group in the second configuration information. For example, the second candidate cell or cell group is a PSCell or SCG corresponding to the first candidate cell or cell group (PCell or MCG). After the terminal accesses the first candidate cell or cell group (PCell or MCG), the terminal may access the corresponding second candidate cell or cell group (PSCell or SCG).

In an optional embodiment, the terminal may access the second candidate cell or cell group only in a case where the terminal has accessed the first candidate cell or cell group.

For example, when the first measurement result meets the first execution condition and the second measurement result meets the second execution condition (the determination order may be arbitrary, and whether the first measurement result meets the first execution condition may be determined first, or whether the second measurement result meets the second execution condition may be determined first), the terminal determines that it can access the first candidate cell or cell group and the second candidate cell or cell group. Then, the terminal can first access the first candidate cell or cell group before accessing the second candidate cell or cell group.

Alternatively, when the first measurement result meets the first execution condition but the second measurement result does not meet the second execution condition, the terminal determines that the terminal can access the first candidate cell or cell group but cannot access the second candidate cell or cell group. Then, the terminal can access the first candidate cell or cell group but cannot access the second candidate cell or cell group.

Alternatively, when the first measurement result does not meet the first execution condition but the second measurement result meets the second execution condition, the terminal determines that the terminal cannot access the first candidate cell or cell group. At this time, the terminal can determine to access the second candidate cell or cell group, or the terminal can determine not to access the second candidate cell or cell group. Thus, the terminal cannot access the first candidate cell or cell group, nor can it access the second candidate cell or cell group.

In a possible embodiment, the UE initiates relevant measurements based on measurement identities. The UE obtains the first measurement result corresponding to the first measurement identity indicated by the first execution condition, and obtains the second measurement result corresponding to the second measurement identity indicated by the second execution condition.

For example, for measurement identities with an associated report type of conditional trigger, if there are execution conditions (condExecutionCond or condExecutionCondSCG) configured by the network for indicating these measurement identities, the UE starts corresponding measurements, regardless of whether the measurement configurations corresponding to these execution conditions are directly or indirectly stored in VarConditionalReconfig.

For example, for a measurement identity stored in the UE, if the report type in the associated report configuration is conditional trigger (condTriggerConfig), and the measurement identity is indicated by the first execution condition corresponding to the first conditional reconfiguration identity (a first configuration identity) in VarConditionalReconfig, if the UE meets other condition(s) related to obtaining of the measurement result, the UE obtains the measurement result corresponding to this measurement identity.

The other condition(s) related to obtaining of the measurement result includes (include), but not limited to, one or more of the following:
1. if a measurement gap configuration is setup, or
2. if the UE does not require measurement gaps to perform the concerned measurements (if the terminal does not require a measurement gap when performing the measurement):
3. if s-MeasureConfig is not configured, or (the first measurement configuration (s-MeasureConfig) is not configured, and the first measurement configuration is used to measure the quality of the serving cell, or)
4. if s-MeasureConfig is set to ssb-RSRP and the NR SpCell RSRP based on SS/PBCH block, after layer 3 filtering, is lower than ssb-RSRP, or (the first measurement configuration is configured as the first SSB-RSRP, and the second SSB-RSRP of the sPCell after layer 3 filtering is lower than the first SSB-RSRP, or)
5. if s-MeasureConfig is set to csi-RSRP and the NR SpCell RSRP based on CSI-RS, after layer 3 filtering, is lower than csi-RSRP: (the first measurement configuration is configured as the first CSI-RSRP, and the second CSI-RSRP of the sPCell after layer 3 filtering is lower than the first CSI-RSRP).

For example, for a measurement identity stored in the UE, if the report type in the associated report configuration is conditional trigger and the measurement identity is indicated by a second execution condition, where the second execution condition is an execution condition corresponding to the second conditional reconfiguration identity included in the second conditional reconfiguration configuration information included in the first condRRCReconfig corresponding to the first conditional reconfiguration identity in VarConditionalReconfig, if the UE meets other condition(s) related to obtaining of the measurement result, the UE obtains the measurement result corresponding to the measurement identity.

For example, the UE evaluates whether the first execution condition is met based on the measurement results corresponding to the first execution condition and the second execution condition. In response to the first measurement result of the first candidate cell group indicated in the first RRCReconfiguration in the first condRRCReconfig meeting the first execution condition, the UE applies the first condRRCReconfig; the UE evaluates whether the second measurement result of the second candidate cell or cell group indicated in the second RRCReconfiguration in the second condRRCReconfig meets the second execution condition based on the second measurement result for the second measurement identity indicated by the second execution condition, and in response to the second execution condition being met, the UE applies the second condRRCReconfig.

The UE applies the first condRRCReconfig, that is, the UE triggers CHO and accesses a candidate MCG (the first candidate cell or cell group). The UE applies the second condRRCReconfig, that is, the UE triggers CPA or CPC and accesses a candidate SCG (the second candidate cell or cell group). The first candidate cell or cell group is associated with the second candidate cell or cell group.

For example, the UE evaluates whether the first execution condition and the second execution condition are met based on the measurement results corresponding to the first execution condition and the second execution condition. In response to the first measurement result of the first candidate cell or cell group indicated in the first RRCReconfiguration in the first condRRCReconfig meeting the first execution condition and the second measurement result of the second candidate cell or cell group indicated in the second RRCReconfiguration in the second condRRCReconfig meeting the second execution condition, the UE applies the first condRRCReconfig and the second condRRCReconfig.

The UE applies the first condRRCReconfig, that is, the UE triggers CHO and accesses the candidate MCG (the first candidate cell or cell group). The UE applies the second condRRCReconfig, that is, the UE triggers CPA or CPC and accesses the candidate SCG (the second candidate cell or cell group). The first candidate cell or cell group is associated with the second candidate cell or cell group.

In view of the above, in the technical solutions provided in the embodiments, when configuration information for two kinds of measurements is jointly configured, for example, the first configuration information and the second configuration information are configured in the first message, and there are measurement identities in the first configuration information and the second configuration information, the terminal can obtain the corresponding measurement result according to the measurement identity in the first configuration information, and can obtain the corresponding measurement result according to the measurement identity in the second configuration information, thereby improving the cell measurement efficiency of the terminal.

Referring to FIG. 5b, a flowchart of a cell measurement method provided by an embodiment of the present disclosure is shown. The embodiment is illustrated by taking an example in which the method is applied to a network device in the communication system shown in FIG. 1. The method may include the following steps:

In step 310, a first message is sent. The first message is used to configure first configuration information and second configuration information. The first configuration information is used to configure a mobility configuration for a first candidate cell or cell group of the terminal. The second configuration information is used to configure a mobility configuration for a second candidate cell or cell group of the terminal.

For example, the network device sends the first message. The first message is used to configure the first configuration information and second configuration information. The first configuration information is used to carry the mobility configuration for the first candidate cell or cell group, so that the terminal obtains a first measurement result corresponding to the first configuration information. The second configuration information is used to carry the mobility configuration for the second candidate cell or cell group, so that the terminal obtains a second measurement result corresponding to the second configuration information.

For example, the network device is an access network device (an access network device of a service cell) to which the terminal currently accesses.

For example, the first configuration information is generated by an access network device (e.g., a candidate MN) of the first candidate cell or cell group, and the second configuration information is generated by an access network device (e.g., a candidate SN) of the second candidate cell or cell group. The access network device (e.g., the candidate MN) of the first candidate cell or cell group sends the first configuration information to an access network device (e.g., a serving MN) of the serving cell, and the access network device (e.g., the candidate SN) of the second candidate cell or cell group sends the second configuration information to an access network device (e.g., the serving MN) of the serving cell. The access network device of the serving cell generates a first message based on the received first configuration information and second configuration information, and sends the first message to the terminal.

For example, the first message is used to configure the first configuration information and/or the second configuration information.

For example, the first message is used to configure first configuration information, and the first configuration information includes the second configuration information (for example, a first conditional RRC reconfiguration field of the first configuration information carries the second configuration information).

For another example, the first message is used to configure the first configuration information. Alternatively, the first message is used to configure the second configuration information.

For another example, the first configuration information is first configured through a second message (the second message may be a message of the same type as the first message). Subsequently, the first configuration information is modified through the first message, and the second configuration information is added to the first configuration information. For example, the terminal receives the second message, and stores the first configuration information configured in the second message into a variable conditional reconfiguration (VarConditionalReconfig), and then the terminal receives the first message, in which the first configuration information is modified, for example, the second configuration information is added to the first conditional RRC reconfiguration field of the first configuration information, and the terminal adds the second configuration information to the first conditional RRC reconfiguration field of the first configuration information in the variable conditional reconfiguration (VarConditionalReconfig) according to the second message.

For example, the first configuration information may be first conditional reconfiguration configuration information or configuration information of a first conditional reconfiguration, and the second configuration information may be second conditional reconfiguration configuration information or configuration information of a second conditional reconfiguration. The first configuration information is used to configure a mobility of an MCG, and the second configuration information is used to configure a mobility of an SCG.

In a possible embodiment, the terminal receives the first conditional reconfiguration configuration information sent by the network side. The first conditional reconfiguration configuration information is used to configure the mobility of the MCG and the mobility of the SCG, and the SCG is associated with the MCG. For example, the first conditional reconfiguration configuration information is used to configure configuration information for CHO and CPA or CPC.

For example, the first conditional reconfiguration configuration information includes one or more pieces of second conditional reconfiguration configuration information, and the second conditional reconfiguration configuration information is used to configure the mobility of the SCG.

In a possible implementation, the first conditional reconfiguration configuration information includes a first configuration identity (condReconfigId), a first execution condition (condExecutionCond) corresponding to MCG mobility (CHO), and a first RRCReconfiguration message (a first condRRCReconfig, a first conditional RRC reconfiguration) that needs to be applied when the first execution condition is met.

In a possible implementation, the first RRCReconfiguration (an RRC reconfiguration) message includes one or more pieces of second conditional reconfiguration configuration information. The first RRCReconfiguration message further includes configuration information for a candidate MCG.

In a possible implementation, the second conditional reconfiguration configuration information includes a second configuration identity, a second execution condition (condExecutionCond or condExecutionCondSCG) corresponding to the SCG mobility (CPA/CPC), and a second RRCReconfiguration message (a second condRRCReconfig) that needs to be applied when the first execution condition is met. The second RRCReconfiguration message further includes configuration information for a candidate SCG.

In a possible implementation, the first execution condition or the second execution condition may be represented by one or more measurement identities.

In a possible embodiment, in response to receiving one or more pieces of first conditional reconfiguration configuration information, the UE stores the configuration information, and stores the configuration information in VarConditionalReconfig (a variable conditional reconfiguration) for storing conditional reconfiguration configuration(s).

In a possible embodiment, the UE initiates relevant measurements based on measurement identities. The terminal obtains a first measurement result corresponding to a first measurement identity indicated by a first execution condition, and obtains a second measurement result corresponding to a second measurement identity indicated by a second execution condition.

For example, for measurement identities with an associated report type of conditional trigger, if there are execution conditions (condExecutionCond or condExecutionCondSCG) configured by the network for indicating these measurement identities, the UE starts corresponding measurements, regardless of whether the measurement configurations corresponding to these execution conditions are directly or indirectly stored in VarConditionalReconfig.

For example, for a measurement identity stored in the UE, if the report type in the associated report configuration is conditional trigger (condTriggerConfig), and the measurement identity is indicated by the first execution condition corresponding to the first conditional reconfiguration identity (a first configuration identity) in VarConditionalReconfig, if the UE meets other condition(s) related to obtaining of the measurement result, the UE obtains the measurement result corresponding to the measurement identity.

The other condition(s) related to obtaining of the measurement result includes (include), but not limited to, one or more of the following:
1. if a measurement gap configuration is setup, or
2. if the UE does not require measurement gaps to perform the concerned measurements (if the terminal does not require a measurement gap when performing the measurement):
3. if s-MeasureConfig is not configured, or (the first measurement configuration (s-MeasureConfig) is not configured, where the first measurement configuration is used to measure the quality of the serving cell, or)
4. if s-MeasureConfig is set to ssb-RSRP and the NR SpCell RSRP based on SS or PBCH block, after layer 3 filtering, is lower than ssb-RSRP, or (the first measurement configuration is configured as the first SSB-RSRP, and the second SSB-RSRP of the sPCell after layer 3 filtering is lower than the first SSB-RSRP, or)
5. if s-MeasureConfig is set to csi-RSRP and the NR SpCell RSRP based on CSI-RS, after layer 3 filtering, is lower than csi-RSRP: (the first measurement configuration is configured as the first CSI-RSRP, and the second CSI-RSRP of the sPCell after layer 3 filtering is lower than the first SCI-RSRP).

For example, for a measurement identity stored in the UE, if the report type in the associated report configuration is conditional trigger and the measurement identity is indicated by a second execution condition, where the second execution condition is an execution condition corresponding to the second conditional reconfiguration identity included in the second conditional reconfiguration configuration information included in the first condRRCReconfig corresponding to the first conditional reconfiguration identity in VarConditionalReconfig, if the UE meets other condition(s) related to obtaining of the measurement result, the UE obtains the measurement result corresponding to the measurement identity.

For example, the UE evaluates whether the first execution condition is met based on the measurement results corresponding to the first execution condition and the second execution condition. In response to the first measurement result of the first candidate cell group indicated in the first RRCReconfiguration in the first condRRCReconfig meeting the first execution condition, the UE applies the first condRRCReconfig; the UE evaluates whether the second measurement result of the second candidate cell or cell group indicated in the second RRCReconfiguration in the second condRRCReconfig meets the second execution condition based on the second measurement result for the second measurement identity indicated by the second execution condition, and in response to the second execution condition being met, the UE applies the second condRRCReconfig.

The UE applies the first condRRCReconfig, that is, the UE triggers CHO and accesses a candidate MCG (the first candidate cell or cell group). The UE applies the second condRRCReconfig, that is, the UE triggers CPA or CPC and accesses a candidate SCG (the second candidate cell or cell group). The first candidate cell or cell group is associated with the second candidate cell or cell group.

For example, the UE evaluates whether the first execution condition and the second execution condition are met based on the measurement results corresponding to the first execution condition and the second execution condition. In response to the first measurement result of the first candidate cell or cell group indicated in the first RRCReconfiguration in the first condRRCReconfig meeting the first execution condition and the second measurement result of the second candidate cell or cell group indicated in the second RRCReconfiguration in the second condRRCReconfig meeting the second execution condition, the UE applies the first condRRCReconfig and the second condRRCReconfig.

The UE applies the first condRRCReconfig, that is, the UE triggers CHO and accesses the candidate MCG (the first candidate cell or cell group). The UE applies the second condRRCReconfig, that is, the UE triggers CPA or CPC and accesses the candidate SCG (the second candidate cell or cell group). The first candidate cell or cell group is associated with the second candidate cell or cell group.

For example, regarding relevant description of the first message, the first configuration information, the second configuration information, the first candidate cell or cell group and the second candidate cell or cell group, reference may be made to the relevant description in the embodiments shown in FIG. 5a.

In view of the above, in the technical solutions provided in the embodiments, when two types of cell measurement configuration information are jointly configured, for example, the first configuration information and the second configuration information are configured in the first message, and there are measurement identities in the first configuration information and the second configuration information. The terminal can obtain the corresponding measurement result according to the measurement identity in the first configuration information, and can obtain the corresponding measurement result according to the measurement identity in the second configuration information, thereby improving the cell measurement efficiency of the terminal.

For example, an example embodiment of a network device sending first configuration information to a terminal is provided.

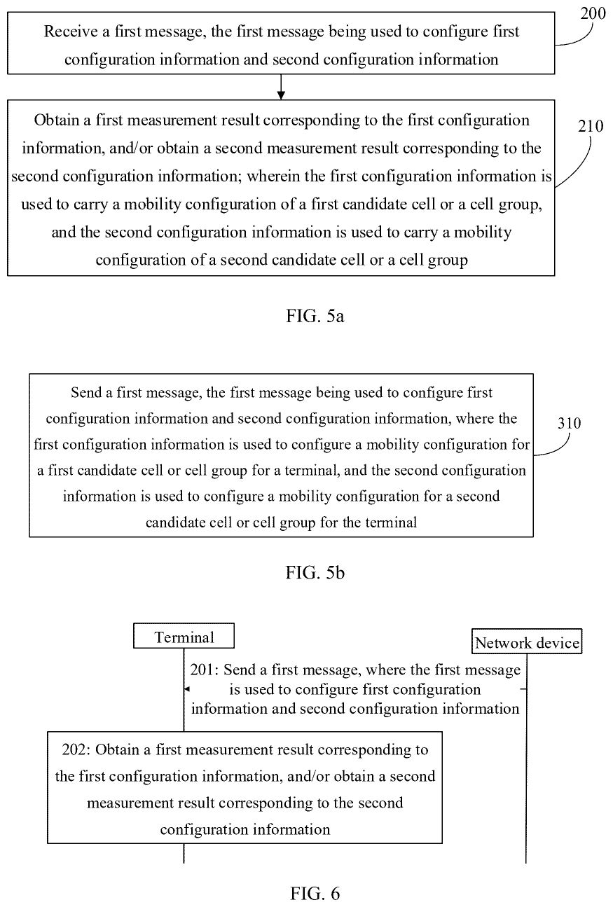

Referring to FIG. 6, a flowchart of a cell measurement method provided by an embodiment of the present disclosure is shown. This embodiment is illustrated by taking an example in which the method is applied to a terminal and a network device in the communication system shown in FIG. 1. The network device may be an access network device or a core network device. Based on the embodiments shown in FIG. 5a, the method further includes step 201 before step 210.

In step 201, a network device sends a first message. The first message is used to configure first configuration information and second configuration information.

For example, the network device is an access network device (an access network device of a service cell) to which the terminal currently accesses.

For example, the first configuration information is generated by an access network device (e.g., a candidate MN) of a first candidate cell or cell group, and the second configuration information is generated by an access network device (e.g., a candidate SN) of a second candidate cell or cell group. The access network device (e.g., the candidate MN) of the first candidate cell or cell group sends the first configuration information to an access network device (e.g., a serving MN) of the serving cell, and the access network device (e.g., the candidate SN) of the second candidate cell or cell group sends the second configuration information to an access network device (e.g., the serving MN) of the serving cell. The access network device of the serving cell generates a first message based on the received first configuration information and second configuration information, and sends the first message to the terminal.

The terminal receives the first configuration information sent by the network device, and stores the first configuration information in a variable conditional reconfiguration (VarConditionalReconfig), and the variable conditional reconfiguration is a terminal variable used by the terminal to store configuration information of accumulated conditional reconfiguration(s).

The configuration information of the accumulated conditional reconfiguration(s) may be as follows: when the network device sends a conditional reconfiguration addition or modification list message, the terminal updates configuration information of conditional reconfiguration(s) that needs to be added or modified in the conditional reconfiguration addition or modification list message to the variable conditional reconfiguration; when the network device sends a conditional reconfiguration removal list message, the terminal removes configuration information of conditional reconfiguration(s) that needs to be removed in the conditional reconfiguration removal list message from the variable conditional reconfiguration. That is, the configuration information stored in the variable conditional reconfiguration is updated in real time according to the configuration of the network device, and new configuration information is updated and stored in the conditional reconfiguration(s).

The variable conditional reconfiguration (VarConditionalReconfig) is used to store received condReconfig (first configuration information). For example, the terminal receives condReconfigToAddModList (a conditional reconfiguration addition or modification list), and adds or updates condReconfig (first configuration information) in condReconfigToAddModList (a conditional reconfiguration addition or modification list) to the variable conditional reconfiguration (VarConditionalReconfig).

For example, the first configuration information may also be referred to as a first condReconfig, or first conditional reconfiguration configuration information, or configuration information of a first conditional reconfiguration. The second configuration information may also be referred to as second condReconfig, or second conditional reconfiguration configuration information, or configuration information of a second conditional reconfiguration.

The first configuration information includes at least one of the following field(s): a first configuration identity (or referred to as a first conditional reconfiguration identity, first condReconfigId), a first execution condition (condExecutionCond or condExecutionCondSCG), or a first conditional RRC reconfiguration (a first condRRCReconfig).

For example, the first execution condition is indicated by a first measurement identity. The variable conditional reconfiguration (VarConditionalReconfig) of the terminal stores: association relationship(s) between measurement identity (identities) (condReconfigId), measurement objects, and report configurations (reportConfig). A report configuration includes an execution condition (or a trigger event). The terminal obtains an execution condition corresponding to the first measurement identity from the variable conditional reconfiguration (VarConditionalReconfig) according to the first measurement identity carried by the first execution condition field, and the execution condition is the first execution condition.

It should be noted that the first execution condition field may carry at least one first measurement identity. When the first execution condition field carries multiple first measurement identities, the terminal obtains an execution condition (trigger event) corresponding to each first measurement identity, and the first execution condition includes the execution condition corresponding to each first measurement identity. The terminal determines that the first execution condition is met only when all these execution conditions are met.

For example, the first conditional RRC reconfiguration field carries a first RRC reconfiguration (RRCReconfiguration) message. The first RRC reconfiguration message carries: configuration information for a first candidate cell or cell group corresponding to the first execution condition (the configuration information is to be applied when the first measurement result meets the first execution condition, that is, the first candidate cell or cell group is accessed when the first measurement result meets the first execution condition), and the second configuration information.

In view of the above, in an optional embodiment, the first configuration information includes at least one of the following information: a first configuration identity, a first measurement identity (used to indicate a first execution condition), or a first RRC reconfiguration message, and the first RRC reconfiguration message includes configuration information for a first candidate cell or cell group and second configuration information.

Alternatively, the first configuration information includes at least one of the following information: a first configuration identity, a first measurement identity (used to indicate a first execution condition), configuration information for the first candidate cell or cell group, or second configuration information.

Alternatively, the first configuration information includes at least one of the following information: a first configuration identity, a first measurement identity (used to indicate a first execution condition) associated with the first configuration identity, configuration information for the first candidate cell or cell group associated with the first configuration identity, a second configuration identity, a second measurement identity (used to indicate a second execution condition) associated with the second configuration identity, or configuration information for a second candidate cell or cell group associated with the second configuration identity.

The second configuration information includes at least one of the following fields: a second configuration identity (or referred to as a second conditional reconfiguration identity, second condReconfigId), a second execution condition (condExecutionCond or condExecutionCondSCG), or a second conditional RRC reconfiguration (a second condRRCReconfig).

For example, the second execution condition is indicated by a second measurement identity. The variable conditional reconfiguration (VarConditionalReconfig) of the terminal stores: association relationship(s) between measurement identity (identities) (condReconfigId), measurement object(s), and report configurations (reportConfig). A report configuration includes an execution condition (or a trigger event). The terminal obtains an execution condition corresponding to the second measurement identity from the variable conditional reconfiguration (VarConditionalReconfig) according to the second measurement identity carried by the second execution condition field, and the execution condition is the second execution condition.

It should be noted that the second execution condition field may carry at least one second measurement identity. When the second execution condition field carries multiple second measurement identities, the terminal obtains an execution condition (trigger event) corresponding to each second measurement identity, and the second execution condition includes the execution condition corresponding to each second measurement identity. The terminal determines that the second execution condition is met only when all these execution conditions are met.

For example, the second conditional RRC reconfiguration field carries a second RRC reconfiguration (RRCReconfiguration) message. The second RRC reconfiguration message carries: configuration information for a second candidate cell or cell group corresponding to the second execution condition (the configuration information is to be applied when the second measurement result meets the second execution condition, that is, the second candidate cell or cell group is accessed when the second measurement result meets the second execution condition).

In view of the above, in an optional embodiment, the second configuration information includes at least one of the following information: a second configuration identity, a second measurement identity (used to indicate a second execution condition), or a second RRC reconfiguration message, and the second RRC reconfiguration message includes configuration information for a second candidate cell or cell group.

Alternatively, the second configuration information includes at least one of the following information: a second configuration identity, a second measurement identity (used to indicate a second execution condition), or configuration information for a second candidate cell or cell group.

It should be noted that the above execution condition (the first execution condition or the second execution condition) is used to determine whether to perform cell access. When a measurement result meets the execution condition, a candidate cell or cell group corresponding to the measurement result is accessed.

For example, the first configuration identity is used to identify the first configuration information, or the first configuration identity is used to associate other information in the first configuration information. Similarly, the second configuration identity is used to identify the second configuration information, or the second configuration identity is used to associate other information in the second configuration information. The first configuration identity is associated with the second configuration identity, and the association relationship between the first configuration identity and the second configuration identity may be used to indicate an inclusion relationship (a nested relationship) between the first configuration information and the second configuration information.

For example, the first configuration information includes at least one piece of second configuration information. That is, the first configuration information includes at least one piece of second configuration information, and/or the first conditional RRC reconfiguration field carries at least one piece of second configuration information, and/or the first RRC reconfiguration message carries at least one piece of second configuration information. One piece of second configuration information is used to configure a mobility configuration for one second candidate cell or cell group, and multiple pieces of second configuration information can configure mobility configurations for multiple second candidate cells or cell groups.

That is, one piece of first configuration information may include at least one piece of second configuration information. The first configuration information is used to configure a first candidate cell or cell group, and the second configuration information is used to configure a second candidate cell or cell group. Accordingly, the first candidate cell or cell group may be associated with at least one second candidate cell or cell group.

For example, an association between information means that one piece of information may be obtained based on another piece of information. For example, the association between the first measurement identity and the first execution condition means that the terminal may obtain the first execution condition from the variable conditional reconfiguration according to the first measurement identity. The association between fields means that information in the field is stored in association. The association between the first candidate cell or cell group and the second candidate cell or cell group means that the first configuration information corresponding to the first candidate cell or cell group and the second configuration information corresponding to the second candidate cell or cell group have an association relationship (a nested relationship), or the measurements corresponding to the first candidate cell or cell group and the second candidate cell or cell group are started in association, or cell access towards the first candidate cell or cell group and the second candidate cell or cell group is triggered in association. For example, after the first execution condition corresponding to the first candidate cell or cell group is met, whether the second execution condition corresponding to the second candidate cell or cell group is met is determined. If the second execution condition is met, the second candidate cell or cell group is accessed; otherwise, the second candidate cell or cell group is not accessed. Alternatively, only when the first execution condition and the second execution condition are met at the same time, the first candidate cell or cell group and the second candidate cell or cell group are accessed.

The first candidate cell or cell group may be a candidate PCell or MCG, and the second candidate cell or cell group may be a candidate PCell or SCG. Alternatively, the first candidate cell or cell group may be a candidate PCell or MCG, and the second candidate cell or cell group may be a candidate PCell or MCG.

In a case where the first candidate cell or cell group includes a candidate primary cell or Master Cell Group (MCG), the second candidate cell or cell group includes a candidate primary secondary cell or Secondary Cell Group (SCG);

Alternatively, in a case where the first candidate cell or cell group includes a first candidate primary cell or MCG, the second candidate cell or cell group includes a second candidate primary cell or MCG. In a case where the terminal accesses the first candidate primary cell or MCG, the second candidate primary cell or MCG may be used as a candidate cell for the first candidate primary cell or MCG. For example, at this time, the candidate primary secondary cell or SCG associated with the first candidate primary cell or MCG may be configured through third configuration information. The third configuration information may be carried in the second message (the second message and the first message may be messages of the same type).

In a case where the first configuration information is used to carry a mobility configuration for a PCell or MCG, the second configuration information is used to carry a mobility configuration for a PSCell or SCG; or, in a case where the first configuration information is used to carry a mobility configuration for a PCell or MCG, the second configuration information is used to carry a mobility configuration for a PCell or MCG; or, in a case where the first configuration information is used to carry a mobility configuration for a PSCell or SCG, the first configuration information cannot include the second configuration information. The mobility configuration for a PCell or MCG includes configuration information for CHO, and the mobility configuration for a PSCell or SCG includes configuration information for CPC and/or CPA.

For example, the first configuration information includes configuration information for Conditional Handover (CHO) for the first candidate cell or cell group, and the second configuration information includes configuration information for Conditional Primary secondary cell Change (CPC) and/or Conditional Primary secondary cell Addition (CPA) for the second candidate cell or cell group.

In an optional embodiment, the terminal receives condReconfigToAddModList (a conditional reconfiguration addition or modification list) sent by the network device, and the network device may configure at least one piece of first configuration information (condReconfig) through condReconfigToAddModList (a conditional reconfiguration addition or modification list). For example, condReconfigToAddModList is as follows:

```
  CondReconfigToAddModList information element (condReconfigToAddModList
information element)
--ASN1START
--TAG-CONDRECONFIGTOADDMODLIST- START
CondReconfigToAddModList-r16 (at least one piece of first configuration information)::=
SEQUENCE (SIZE (1.. maxNrofCondCells-r16)) OF CondReconfigToAddMod-r16
CondReconfigToAddMod-r16 (first configuration information)::= SEQUENCE {
  condReconfigId-r16 (a first configuration identity) CondReconfigId-r16,
  condExecutionCond-16 (a first execution condition) SEQUENCE (SIZE (1..2))
OF MeasId (a first measurement identity) OPTIONAL, -- Need M
  condRRCReconfig-r16 (a first conditional RRC reconfiguration) OCTET STRING
(CONTAINING RRCReconfiguration (a first RRC reconfiguration message)) OPTIONAL, - -
Cond condReconfigAdd
  ...,
  [[
  condExecutionCondSCG-r17 (a first execution condition or a second execution
condition) OCTET STRING (CONTAINING CondReconfigExecCondSCG -r17) OPTIONAL --
Need M
  ]]
}
CondReconfigExecCondSCG-r17::= SEQUENCE (SIZE (1..2)) OF MeasId
--TAG -CONDRECONE IGTOADDMODLIST-STOP
--ASN1S TOP.
```

For example, in response to the first conditional reconfiguration configuration information being used for the mobility of the MCG, the second conditional reconfiguration configuration information included in a candidate target configuration in the first conditional reconfiguration configuration information can only be used for the mobility of the SCG, and cannot be used for the mobility of the MCG.

For example, in response to the first conditional reconfiguration configuration information being used for the mobility of the SCG, the first conditional reconfiguration configuration information cannot include conditional reconfiguration configuration information, that is, the second configuration information cannot be nested in the first configuration information.

In step 202, a first measurement result corresponding to the first configuration information is obtained, and/or a second measurement result corresponding to the second configuration information is obtained.

For example, the terminal obtains the first measurement result corresponding to the first measurement identity according to the first measurement identity in the first configuration information, and obtains the second measurement result corresponding to the second measurement identity according to the second measurement identity in the second configuration information.

Alternatively, the terminal starts a measurement of the first candidate cell or cell group according to the first measurement identity in the first configuration information to obtain the first measurement result, and starts a measurement of the second candidate cell or cell group according to the second measurement identity in the second configuration information to obtain the second measurement result.

For example, when there are multiple first measurement identities, the first measurement result includes multiple measurement results corresponding to the multiple first measurement identities respectively. When there are multiple second measurement identities, the second measurement result includes multiple measurement results corresponding to the multiple second measurement identities respectively.

It should be noted that the terminal stores measurement identity (identities), measurement object(s), and report configuration(s) in association. One measurement identity corresponds to one measurement object, and one measurement identity corresponds to one report configuration. The same measurement object can correspond to multiple measurement identities, and different measurement identities correspond to different report configurations. A report configuration includes information such as an execution condition (trigger event) and a report type.

The first configuration information includes: one first configuration identity, at least one first measurement identity, and configuration information for one first candidate cell or cell group. The all of the at least one first measurement identity is associated with a measurement object which is the first candidate cell or cell group. Different first measurement identities are used to indicate different report configurations (different execution conditions or trigger events) for the first candidate cell or cell group. Accordingly, the first execution condition corresponding to the first candidate cell or cell group includes: at least one execution condition or trigger event associated with the at least one first measurement identity.

Similarly, the second configuration information includes: one second configuration identity, at least one second measurement identity, and configuration information for one second candidate cell or cell group. All of the at least one second measurement identity is associated with a measurement object which the second candidate cell or cell group. Different second measurement identities are used to indicate different report configurations (different execution conditions or trigger events) for the second candidate cell or cell group. Accordingly, the second execution condition corresponding to the second candidate cell or cell group includes: at least one execution condition or trigger event associated with the at least one second measurement identity.

For example, the first measurement result obtained according to the first measurement identity is a measurement result of the first candidate cell or cell group, and the second measurement result obtained according to the second measurement identity is a measurement result of the second candidate cell or cell group.

Optionally, the terminal determines whether to access the first candidate cell or cell group based on whether the first measurement result meets the first execution condition indicated by the first measurement identity, and determines whether to access the second candidate cell or cell group based on whether the second measurement result meets the second execution condition indicated by the second measurement identity.

In view of the above, in the technical solutions provided by the embodiments, the network device can use a nested structure to configure the configuration information for CHO and the configuration information for CPA or CPC to the terminal. For example, the configuration information for CHO includes the configuration information for CPA or CPC. The terminal can start the measurements corresponding to CHO and CPA or CPC according to the configuration of the network device. If the configuration information corresponding to CHO includes the configuration information for CPAC, a corresponding measurement is also started for a measurement identity in the configuration information for CPAC. Thus, the technical solutions can improve the cell measurement efficiency of the terminal.

For example, there is provided an example embodiment in which a terminal obtains measurement results according to a first measurement identity and a second measurement identity.

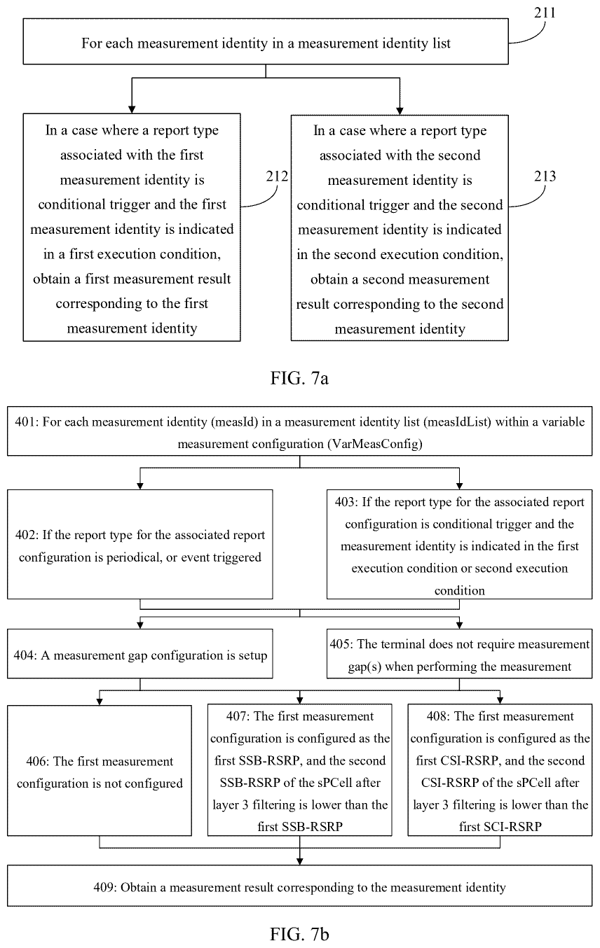

Referring to FIG. 7a, a flowchart of a cell measurement method provided by an embodiment of the present disclosure is shown. This embodiment is illustrated by taking an example in which the method is applied to a terminal in the communication system shown in FIG. 1. Based on the embodiments shown in FIG. 5a, step 210 includes step 211, step 212 and step 213.

In step 211, for each measurement identity in a measurement identity list, step 212 and/or step 213 is (are) performed.

For example, the terminal stores a measurement identity list, and the measurement identity list includes at least one measurement identity. The measurement identity list may be formed by measurement identity (identities) in a variable conditional reconfiguration (VarConditionalReconfig). The measurement identity list includes a first measurement identity and a second measurement identity.

Optionally, in some implementation of the present disclosure, the terminal may store the measurement identity (identities) in other ways, which is not limited to the measurement identity list mentioned above.

In step 212, in a case where a report type associated with the first measurement identity is conditional trigger and the first measurement identity is indicated in a first execution condition, a first measurement result corresponding to the first measurement identity is obtained.

Optionally, the variable conditional reconfiguration (VarConditionalReconfig) of the terminal stores association relationship(s) between measurement identity (identities) and report configuration(s), and a report configuration includes a report type. The report type includes at least one of: conditional trigger, event triggered, or periodical.

For example, for measurement identities with an associated report type to be conditional trigger, if there are execution conditions configured by the network (the first execution condition: condExecutionCond or condExecutionCondSCG or the second execution condition: condExecutionCond or condExecutionCondSCG) indicating these measurement identities, the UE starts the corresponding measurements, regardless of whether the measurement configurations corresponding to these execution conditions are directly or indirectly stored in VarConditionalReconfig. Direct storage means that the first configuration information is directly stored in VarConditionalReconfig, and indirect storage means that the second configuration information is nested in the first configuration information and stored in VarConditionalReconfig.

For example, when a report type for a measurement identity is conditional trigger, and the network device configures configuration information of a conditional reconfiguration (first configuration information or second configuration information) for the measurement identity, the terminal may start a measurement corresponding to the measurement identity and obtain a measurement result.

For example, for a first measurement identity in the measurement identity list, if a report type in a report configuration associated with the first measurement identity is conditional trigger and a first execution condition field in the first configuration information indicates the first measurement identity, the terminal starts a measurement corresponding to the first measurement identity and obtains a first measurement result.

For example, for a measurement identity stored in the UE, if a report type in the associated report configuration is conditional trigger (condTriggerConfig) and the measurement identity is indicated by the first execution condition corresponding to the first configuration identity in VarConditionalReconfig, if the UE meets other condition(s) related to obtaining of the measurement result (first result obtaining condition(s)), the UE obtains a measurement result corresponding to the measurement identity.

For example, in a case where the report type associated with the first measurement identity is conditional trigger, the first measurement identity is indicated in the first execution condition and the terminal meets the first result obtaining condition, a first measurement result corresponding to the first measurement identity is obtained.

The first result obtaining condition(s) includes (include) at least one of the following condition(s) that: a measurement gap configuration is setup; the terminal does not require measurement gap(s) to perform the measurement; the first measurement configuration (s-MeasureConfig) is not configured, where the first measurement configuration is used to measure the quality of the serving cell; the first measurement configuration is configured as a first Synchronization Signal or Physical Broadcast Channel Block-Reference Signal Received Power (SSB-RSRP), and a second SSB-RSRP of the special cell (sPCell, including PCell and/or PSCell) after layer 3 filtering is lower than the first SSB-RSRP; the first measurement configuration is configured as a Channel State Information-Reference Signal Received Power (CSI-RSRP), and a second CSI-RSRP of the special cell (sPCell, including PCell and/or PSCell) after layer 3 filtering is lower than the first CSI-RSRP.

In step 213, in a case where a report type associated with the second measurement identity is conditional trigger and the second measurement identity is indicated in the second execution condition, a second measurement result corresponding to the second measurement identity is obtained.

For example, for the second measurement identity in the measurement identity list, if a report type in a report configuration associated with the second measurement identity is conditional trigger, and a second execution condition field in the second configuration information indicates the second measurement identity, the terminal starts a measurement corresponding to the second measurement identity and obtains the second measurement result.

For example, in a case where the report type associated with the second measurement identity is conditional trigger type, the second measurement identity is indicated in the second execution condition and the terminal meets second result obtaining condition(s), the terminal obtains the second measurement result corresponding to the second measurement identity.

The second result obtaining condition(s) includes (include) at least one of the following condition(s) that: a measurement gap configuration is setup; the terminal does not require measurement gap(s) to perform the measurement; the first measurement configuration (s-MeasureConfig) is not configured, where the first measurement configuration is used to measure the quality of the serving cell; the first measurement configuration is configured as first synchronization signal or physical broadcast channel block reference signal received power (Synchronization Signal/Physical Broadcast Channel Block-Reference Signal Received Power SSB-RSRP), and the second SSB-RSRP of the special cell (sPCell, including PCell and/or PSCell) after layer 3 filtering is lower than the first SSB-RSRP; the first measurement configuration is configured as the first Channel State Information-Reference Signal Received Power (CSI-RSRP), and the second CSI-RSRP of the special cell (sPCell, including PCell and/or PSCell) after layer 3 filtering is lower than the first SCI-RSRP.

In an optional embodiment, as shown in FIG. 7b, an example embodiment in which a terminal starts a measurement or obtains a measurement result is provided. The method may include the following steps.

In step 401, for each measurement identity (measId) in a measurement identity list (measIdList) within a variable measurement configuration (VarMeasConfig) (for each measId included in the measIdList within VarMeasConfig).

For example, for each measurement identity in the measurement identity list, a corresponding report type for the measurement identity is determined. If the report type is periodical or event triggered, step 402 is performed; if the report type is conditional trigger, step 403 is performed.

In step 402, if the reportType (report type) for the associated reportConfig (report configuration) is periodical, or eventtrigger (event triggered) (if the reportType for the associated reportConfig is periodical, eventTriggered); or.

For example, if the measurement identity meets step 402, whether it meets step 404 or step 405 is further determined. If it meets any one of step 404 or step 405, whether it meets step 406, step 407, step 408 is further determined.

In step 403, if the reportType (report type) for the associated reportConfig (report configuration) is condTriggerConfig (conditional trigger) and the measId (measurement identity) is indicated in the condExecutionCond (the first execution condition or second execution condition) or in the condExecutionCondSCG (the first execution condition or second execution) (if the reportType for the associated reportConfig is condTriggerConfig and the measId is indicated in the condExecutionCond or in the condExecutionCondSCG).

For example, if the measurement identity meets step 403, whether it meets step 404 or step 405 is further determined; if it meets any one of step 404 or step 405, whether it meets step 406, step 407, step 408 is further determined.

For example, the terminal may directly perform step 409 after step 403 is met. Alternatively, the terminal may perform any determination step in step 404 to step 408 after step 403 is met, and then performs step 409.

For example, the terminal may also combine step 403 with other steps (e.g., other conditions that the terminal needs to meet) to determine whether to perform step 409.

For example, if the measurement identity does not meet step 403 and does not meet step 402, the process is stopped, and the measurement corresponding to the measurement identity is not started or the measurement result corresponding to the measurement identity is not obtained.

In step 404, a measurement gap configuration is setup (if a measurement gap configuration is setup), or

In step 405, the terminal does not require measurement gap(s) when performing the measurement (if the UE does not require measurement gaps to perform the concerned measurements).

For example, if step 404 is not met and step 405 is not met, the process is stopped, and the measurement corresponding to the measurement identity is not started or the measurement result corresponding to the measurement identity is not obtained.

In step 406, the first measurement configuration is not configured (if s-MeasureConfig is not configured), or.

In step 407, the first measurement configuration is configured as the first SSB-RSRP, and the second SSB-RSRP of the sPCell after layer 3 filtering is lower than the first SSB-RSRP (if s-MeasureConfig is set to ssb-RSRP and the NR SpCell RSRP based on SS or PBCH block, after layer 3 filtering, is lower than ssb-RSRP), or.

In step 408, the first measurement configuration is configured as the first CSI-RSRP, and the second CSI-RSRP of the sPCell after layer 3 filtering is lower than the first SCI-RSRP (if s-MeasureConfig is set to csi-RSRP and the NR SpCell RSRP based on CSI-RS, after layer 3 filtering, is lower than csi-RSRP).

For example, if step 406 is not met, step 407 is not met, and step 408 is not met, the process is stopped, and the measurement corresponding to the measurement identity is not started or the measurement result corresponding to the measurement identity is not obtained.

In step 409, a measurement result corresponding to the measurement identity is obtained (derive measurement results).

For example, if any one of step 406, step 407, step 408 is met, step 409 is performed to obtain the measurement result corresponding to the measurement identity.

In view of the above, in the technical solutions provided in the embodiments, the terminal can start the measurement to obtain the second measurement result corresponding to the second measurement identity in a case where the report type for the second measurement identity is conditional trigger and the second measurement identity is indicated by the second execution condition field. Thus, the technical solutions can improve the measurement efficiency of the terminal and reduce the evaluation delay of CPAC.

For example, there is provided another example embodiment in which a terminal obtains measurement result(s) according to a first measurement identity and a second measurement identity.

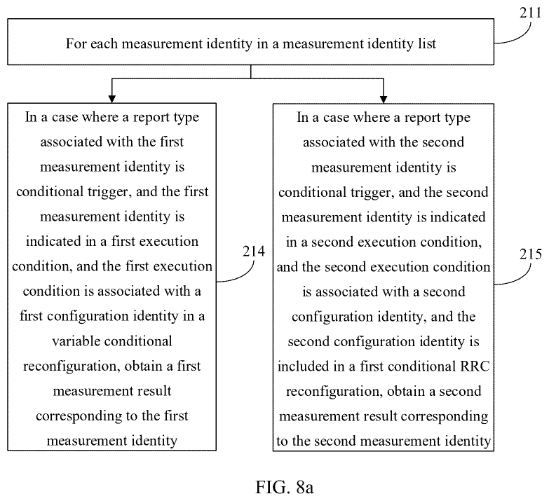

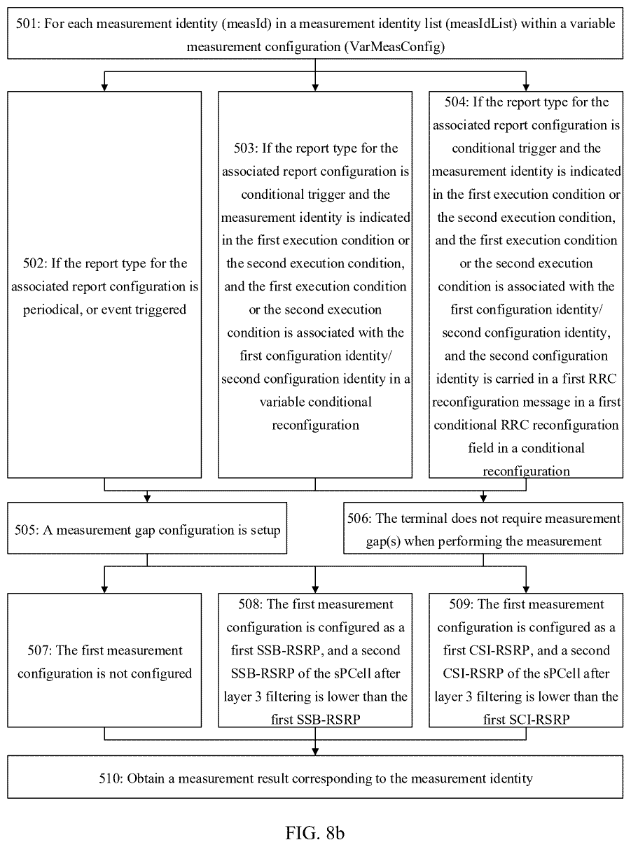

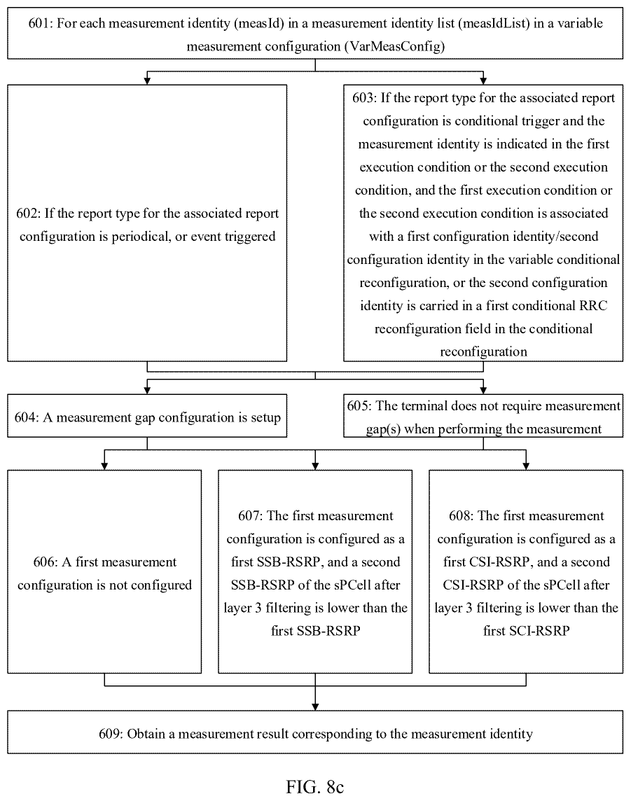

Referring to FIG. 8a, a flowchart of a cell measurement method provided by an embodiment of the present disclosure is shown. This embodiment is illustrated by taking an example in which the method is applied to a terminal in the communication system shown in FIG. 1. Based on the embodiment shown in FIG. 5a, step 210 includes step 211, step 214 and step 215.

In step 211, for each measurement identity in a measurement identity list, step 214 and/or step 215 is (are) performed.

For example, the measurement identity list includes a first measurement identity and a second measurement identity.

In step 214, in a case where a report type associated with the first measurement identity is conditional trigger, and the first measurement identity is indicated in a first execution condition, and the first execution condition is associated with a first configuration identity in a variable conditional reconfiguration, a first measurement result corresponding to the first measurement identity is obtained.

For example, in a case where the report type associated with the first measurement identity is conditional trigger, and the first measurement identity is indicated in the first execution condition, and the first execution condition is associated with the first configuration identity in the variable conditional reconfiguration, and the terminal meets first result obtaining condition(s), the first measurement result corresponding to the first measurement identity is obtained.

The first result obtaining condition(s) includes (include) at least one of the following condition(s): a measurement gap configuration is setup; the terminal does not require measurement gap(s) to perform the measurement; a first measurement configuration (s-MeasureConfig) is not configured, where the first measurement configuration is used to measure the quality of the serving cell; the first measurement configuration is configured as a first SSB-RSRP, and a second SSB-RSRP of the special cell (sPCell, including PCell and/or PSCell) after layer 3 filtering is lower than the first SSB-RSRP; the first measurement configuration is configured as a first CSI-RSRP, and a second CSI-RSRP of the special cell (sPCell, including PCell and/or PSCell) after layer 3 filtering is lower than the first SCI-RSRP.

In step 215, in a case where a report type associated with the second measurement identity is conditional trigger, and the second measurement identity is indicated in a second execution condition, and the second execution condition is associated with a second configuration identity, and the second configuration identity is included in a first conditional RRC reconfiguration, a second measurement result corresponding to the second measurement identity is obtained.

The first conditional RRC reconfiguration is included in a variable conditional reconfiguration.

For example, in a case where the report type associated with the second measurement identity is conditional trigger, and the second measurement identity is indicated in the second execution condition, and the second execution condition is associated with the second configuration identity, and the second configuration identity is included in the first conditional RRC reconfiguration and the terminal meets second result obtaining condition(s), the second measurement result corresponding to the second measurement identity is obtained.

The second result obtaining condition(s) includes (include) at least one of the following condition(s) that: a measurement gap configuration is setup; the terminal does not require measurement gap to perform the measurement; the first measurement configuration (s-MeasureConfig) is not configured, where the first measurement configuration is used to measure the quality of the serving cell; the first measurement configuration is configured as a first SSB-RSRP, and a second SSB-RSRP of the special cell (sPCell, including PCell and/or PSCell) after layer 3 filtering is lower than the first SSB-RSRP; the first measurement configuration is configured as a first CSI-RSRP, and a second CSI-RSRP of the special cell (sPCell, including PCell and/or PSCell) after layer 3 filtering is lower than the first SCI-RSRP.

In an optional embodiment, as shown in FIG. 8b, there is provided an example embodiment in which a terminal starts a measurement or obtains a measurement result. The method may include the following steps.

In step 501, for each measurement identity (measId) in a measurement identity list (measIdList) within a variable measurement configuration (VarMeasConfig) (for each measId included in the measIdList within VarMeasConfig).

For example, for each measurement identity in the measurement identity list, a corresponding report type for the measurement identity is determined. If the report type is periodical or event triggered, step 502 is performed; if the report type is conditional trigger, step 503 is performed. In step 502, if the reportType (report type) for the associated reportConfig (report configuration) is periodical, or eventtrigger (event triggered) (if the reportType for the associated reportConfig is periodical, eventTriggered); or.

For example, if the measurement identity meets step 502, whether it meets step 505 or step 506 is further determined; if it meets any one of step 505 or step 506, whether it meets step 507, step 508, step 509 is further determined.

In step 503, if the reportType (report type) for the associated reportConfig (report configuration) is condTriggerConfig (conditional trigger) and the measurement identity (measId) is indicated in the condExecutionCond (the first execution condition or second execution condition) or in the condExecutionCondSCG (the first execution condition or second execution condition) associated to a first configuration identity or a second configuration identity (condReconfigId) in a variable conditional reconfiguration (VarConditionalReconfig) (if the reportType for the associated reportConfig is condTriggerConfig and the measId is indicated in the condExecutionCond or in the condExecutionCondSCG associated to a condReconfigId in VarConditionalReconfig); or.

For example, if the measurement identity meets step 503, whether it meets step 505 or step 506 is further determined; if it meets any one of step 505 or step 506, whether it meets step 507, step 508, step 509 is further determined.

In step 504, if the reportType (report type) for the associated reportConfig (report configuration) is condTriggerConfig (conditional trigger) and the measId (measurement identity) is indicated in the condExecutionCond (the first execution condition or the second execution condition) or in the condExecutionCondSCG (the first execution condition or the second execution condition), and the condExecutionCond (the first execution condition or the second execution condition) or the condExecutionCondSCG (the first execution condition or the second execution condition) is associated with a first configuration identity or a second configuration identity (condReconfigId), and the second configuration identity (condReconfigId) is carried in the first RRC reconfiguration message (RRCReconfiguration) in the first conditional RRC reconfiguration (conditionalReconfiguration) field of the conditional reconfiguration (conditionalReconfiguration) (if the reportType for the associated reportConfig is condTriggerConfig and the measId is indicated in the condExecutionCond or in the condExecutionCondSCG associated to a condReconfigId, and the condReconfigId is included in conditionalReconfiguration in the RRCReconfiguration within condRRCReconfig).

For example, if the measurement identity meets step 504, whether it meets step 505 or step 506 is further determined; if it meets any one of step 505 or step 506, whether it meets step 507, step 508, step 509 is further determined.

For example, the terminal may directly perform step 510 after step 504 is met. Alternatively, the terminal may perform any determination step in step 505 to step 509 after step 504 is met, and perform step 510 after the determination step is met.

For example, the terminal may also combine step 504 with other steps (e.g., other conditions that the terminal needs to meet) to determine whether to perform step 510.

For example, if the measurement identity does not meet step 502, does not meet step 503, and does not meet step 504, the process is stopped, and the measurement corresponding to the measurement identity is not started or the measurement result corresponding to the measurement identity is not obtained.

In step 505, a measurement gap configuration is setup (if a measurement gap configuration is setup), or

In step 506, the terminal does not require measurement gap(s) when performing the measurement (if the UE does not require measurement gaps to perform the concerned measurements).

For example, if step 505 is not met and step 506 is not met, the process is stopped, and the measurement corresponding to the measurement identity is not started or the measurement result corresponding to the measurement identity is not obtained.

In step 507, the first measurement configuration is not configured (if s-MeasureConfig is not configured), or.

In step 508, the first measurement configuration is configured as a first SSB-RSRP, and a second SSB-RSRP of the sPCell after layer 3 filtering is lower than the first SSB-RSRP (if s-MeasureConfig is set to ssb-RSRP and the NR SpCell RSRP based on SS or PBCH block, after layer 3 filtering, is lower than ssb-RSRP), or.

In step 509, the first measurement configuration is configured as a first CSI-RSRP, and a second CSI-RSRP of the sPCell after layer 3 filtering is lower than the first SCI-RSRP (if s-MeasureConfig is set to csi-RSRP and the NR SpCell RSRP based on CSI-RS, after layer 3 filtering, is lower than csi-RSRP).

For example, if step 507 is not met, step 508 is not met, and step 509 is not met, the process is stopped, and the measurement corresponding to the measurement identity is not started or the measurement result corresponding to the measurement identity is not obtained.

. . . In step 510, a measurement result is obtained (derive measurement results).

For example, if any one of step 507, step 508, step 509 is met, step 510 is performed to obtain the measurement result corresponding to the measurement identity.

In another optional embodiment, as shown in FIG. 8c, there is provided an example embodiment in which a terminal starts a measurement or obtains a measurement result. The method includes the following steps.

In step 601, for each measurement identity (measId) in a measurement identity list (measIdList) in a variable measurement configuration (VarMeasConfig) (for each measId included in the measIdList within VarMeasConfig).

For example, for each measurement identity in the measurement identity list, a corresponding report type for the measurement identity is determined. If the report type is periodical or event triggered, step 602 is performed; if the report type is conditional trigger, step 603 is performed.

In step 602, if the reportType (report type) for the associated reportConfig (report configuration) is periodical, or eventtrigger (event triggered) (if the reportType for the associated reportConfig is periodical, eventTriggered); or.

For example, if the measurement identity meets step 602, whether it meets step 604 or step 605 is further determined; if it meets any one of step 604 or step 605, whether it meets step 606, step 607, step 608 is further determined.

In step 603, if the reportType (report type) for the associated reportConfig (report configuration) is condTriggerConfig (conditional trigger) and the measId (measurement identity) is indicated in the condExecutionCond (the first execution condition or the second execution condition) or in the condExecutionCondSCG (the first execution condition or the second execution condition), and the condExecutionCond (the first execution condition or the second execution condition) or condExecutionCondSCG (the first execution condition or the second execution condition) is associated with a first configuration identity or a second configuration identity (condReconfigId) in the variable conditional reconfiguration (VarConditionalReconfig), or the second configuration identity (condReconfigId) is carried in the first conditional RRC reconfiguration (conditionalReconfiguration) field in the conditional reconfiguration (conditionalReconfiguration) (if the reportType for the associated reportConfig is condTriggerConfig and the measId is indicated in the condExecutionCond or in the condExecutionCondSCG associated to a condReconfigId in VarConditionalReconfig or a condReconfigId in a conditionalReconfiguration within conditionalReconfiguration).

For example, if the measurement identity meets step 603, whether it meets step 604 or step 605 is further determined; if it meets any one of step 604 or step 605, whether it meets step 606, step 607, step 608 is further determined.

For example, the terminal may directly perform step 609 after meeting step 603. Alternatively, the terminal may perform any determination step in step 604 to step 608 after meeting step 603, and perform step 609 after meeting the determination step.

For example, the terminal may also combine step 603 with other steps (e.g., other conditions that the terminal needs to meet) to determine whether to perform step 609.

For example, if the measurement identity does not meet step 603 and does not meet step 602, the process is stopped, and the measurement corresponding to the measurement identity is not started or the measurement result corresponding to the measurement identity is not obtained.

In step 604, a measurement gap configuration is setup (if a measurement gap configuration is setup), or.

In step 605, the terminal does not require measurement gap(s) when performing the measurement (if the UE does not require measurement gaps to perform the concerned measurements).

For example, if step 604 is not met and step 605 is not met, the process is stopped, and the measurement corresponding to the measurement identity is not started or the measurement result corresponding to the measurement identity is not obtained.

In step 606, a first measurement configuration is not configured (if s-MeasureConfig is not configured), or.

In step 607, the first measurement configuration is configured as a first SSB-RSRP, and a second SSB-RSRP of the sPCell after layer 3 filtering is lower than the first SSB-RSRP (if s-MeasureConfig is set to ssb-RSRP and the NR SpCell RSRP based on SS or PBCH block, after layer 3 filtering, is lower than ssb-RSRP), or.

In step 608, the first measurement configuration is configured as a first CSI-RSRP, and a second CSI-RSRP of the sPCell after layer 3 filtering is lower than the first SCI-RSRP (if s-MeasureConfig is set to csi-RSRP and the NR SpCell RSRP based on CSI-RS, after layer 3 filtering, is lower than csi-RSRP).

For example, if step 606 is not met, step 607 is not met, and step 608 is not met, the process is stopped, and the measurement corresponding to the measurement identity is not started or the measurement result corresponding to the measurement identity is not obtained.

. . . In step 609, a measurement result is obtained (derive measurement results).

For example, if any one of step 606, step 607, step 608 is met, step 609 is performed to obtain the measurement result corresponding to the measurement identity.

In view of the above, in the technical solutions provided in the embodiments, the terminal can start the measurement to obtain the second measurement result corresponding to the second measurement identity in a case where the report type of the second measurement identity is conditional trigger, and the second measurement identity is indicated by the second execution condition field, and the second execution condition is associated with the second configuration identity, and the second configuration identity is included in the first conditional RRC reconfiguration field. Accordingly, the technical solutions can improve the measurement efficiency of the terminal and reduce the evaluation delay of CPAC.

For example, there is provided another example embodiment in which a terminal obtains measurement result(s) according to a first measurement identity and a second measurement identity.

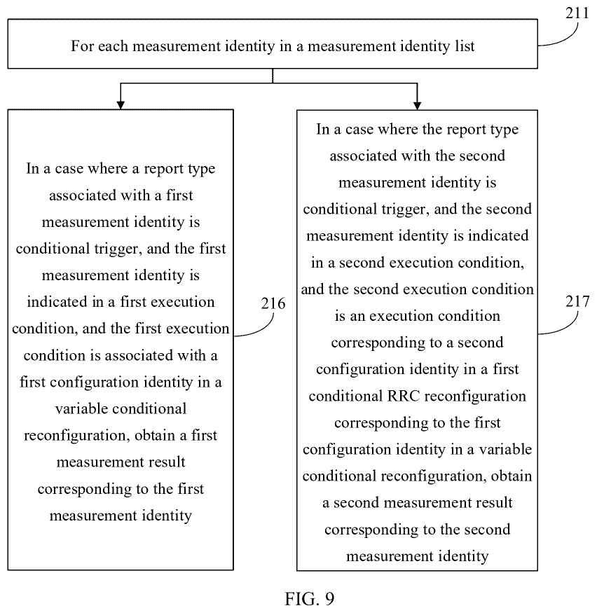

Referring to FIG. 9, a flowchart of a cell measurement method provided by an embodiment of the present disclosure is shown. This embodiment is illustrated by taking an example in which the method is applied to a terminal in the communication system shown in FIG. 1. Based on the embodiments shown in FIG. 5a, step 210 includes step 211, step 216 and step 217.

In step 211, for each measurement identity in a measurement identity list, step 216 and/or step 217 is (are) performed.

In step 216, in a case where a report type associated with a first measurement identity is conditional trigger, and the first measurement identity is indicated in a first execution condition, and the first execution condition is associated with a first configuration identity in a variable conditional reconfiguration, a first measurement result corresponding to the first measurement identity is obtained.

For example, in a case where the report type associated with the first measurement identity is conditional trigger, and the first measurement identity is indicated in the first execution condition, and the first execution condition is associated with the first configuration identity in the variable conditional reconfiguration and the terminal meets first result obtaining condition(s), the first measurement result corresponding to the first measurement identity is obtained.

The first result obtaining condition(s) includes (include) at least one of the following condition(s) that: a measurement gap configuration is setup; the terminal does not require measurement gap(s) to perform the measurement; a first measurement configuration (s-MeasureConfig) is not configured, where the first measurement configuration is used to measure the quality of the serving cell; the first measurement configuration is configured as a first SSB-RSRP, and a second SSB-RSRP of the special cell (sPCell, including PCell and/or PSCell) after layer 3 filtering is lower than the first SSB-RSRP; the first measurement configuration is configured as a first CSI-RSRP, and the second CSI-RSRP of the special cell (sPCell, including PCell and/or PSCell) after layer 3 filtering is lower than the first SCI-RSRP.

For example, in a case where the report type associated with the first measurement identity is periodical or event triggered, the measurement may be started or the measurement result may be obtained according to any one of the embodiments shown in FIG. 7b, FIG. 8b, FIG. 8c.

For example, in a case where the report type associated with the first measurement identity is conditional trigger and the first measurement identity is not indicated in an execution condition (the network device does not configure configuration information including the first measurement identity or configuration information of a conditional reconfiguration), the measurement corresponding to the first measurement identity is not started, or the first measurement result corresponding to the first measurement identity is not obtained.

In step 217, in a case where the report type associated with the second measurement identity is conditional trigger, and the second measurement identity is indicated in a second execution condition, and the second execution condition is an execution condition corresponding to a second configuration identity in a first conditional RRC reconfiguration corresponding to the first configuration identity in a variable conditional reconfiguration, a second measurement result corresponding to the second measurement identity is obtained.

For example, for a measurement identity stored in the UE, if a report type in an associated report configuration is conditional trigger and the measurement identity is indicated by a second execution condition, where the second execution condition is an execution condition corresponding to a second conditional reconfiguration identity included in second conditional reconfiguration configuration information included in first condRRCReconfig corresponding to a first conditional reconfiguration identity in VarConditionalReconfig, if the UE meets other condition(s) related to obtaining of the measurement result (second result obtaining condition(s)), the UE obtains the measurement result corresponding to the measurement identity.

For example, the report type associated with the second measurement identity is conditional trigger, and the second measurement identity is indicated in the second execution condition, and the second execution condition is an execution condition corresponding to the second configuration identity in the first conditional RRC reconfiguration corresponding to the first configuration identity in the variable conditional reconfiguration and the terminal meets the second result obtaining condition(s), the terminal obtains the second measurement result corresponding to the second measurement identity.

The second result obtaining condition(s) includes (include) at least one of the following condition(s) that: a measurement gap configuration is setup; the terminal does not require measurement gap(s) to perform the measurement; a first measurement configuration (s-MeasureConfig) is not configured, where the first measurement configuration is used to measure the quality of the serving cell; the first measurement configuration is configured as a first SSB-RSRP, and a second SSB-RSRP of the special cell (sPCell, including PCell and/or PSCell) after layer 3 filtering is lower than the first SSB-RSRP; the first measurement configuration is configured as a first CSI-RSRP, and a second CSI-RSRP of the special cell (sPCell, including PCell and/or PSCell) after layer 3 filtering is lower than the first SCI-RSRP.

For example, in a case where the report type associated with the second measurement identity is periodical or event triggered, the measurement may be started or the measurement result may be obtained according to any one of the embodiments shown in FIG. 7b, FIG. 8b, FIG. 8c.

For example, in a case where the report type associated with the second measurement identity is conditional trigger and the second measurement identity is not indicated in an execution condition (the network device does not configure configuration information including the second measurement identity or configuration information of a conditional reconfiguration), the measurement corresponding to the second measurement identity is not started, or the second measurement result corresponding to the second measurement identity is not obtained.

In view of the above, in the technical solutions provided in the embodiments, the terminal can start the measurement to obtain the first measurement result corresponding to the first measurement identity in a case where the report type for the first measurement identity is conditional trigger and the first measurement identity is indicated by the first execution condition field and the first measurement identity is associated with the first configuration identity; and the terminal can start the measurement to obtain the second measurement result corresponding to the second measurement identity in a case where the report type for the second measurement identity is conditional trigger, and the second measurement identity is indicated by the second execution condition field, and the second execution condition is the execution condition corresponding to the second configuration identity in the first conditional RRC reconfiguration corresponding to the first configuration identity. Accordingly, the technical solutions can improve the measurement efficiency of the terminal and reduce the evaluation delay of CPAC.

For example, there is provided an example embodiment in which a terminal performs CHO evaluation according to a first measurement result and performs CPAC evaluation according to a second measurement result.

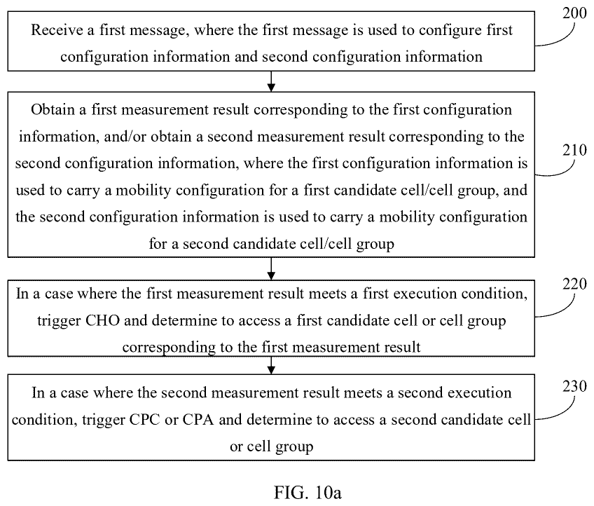

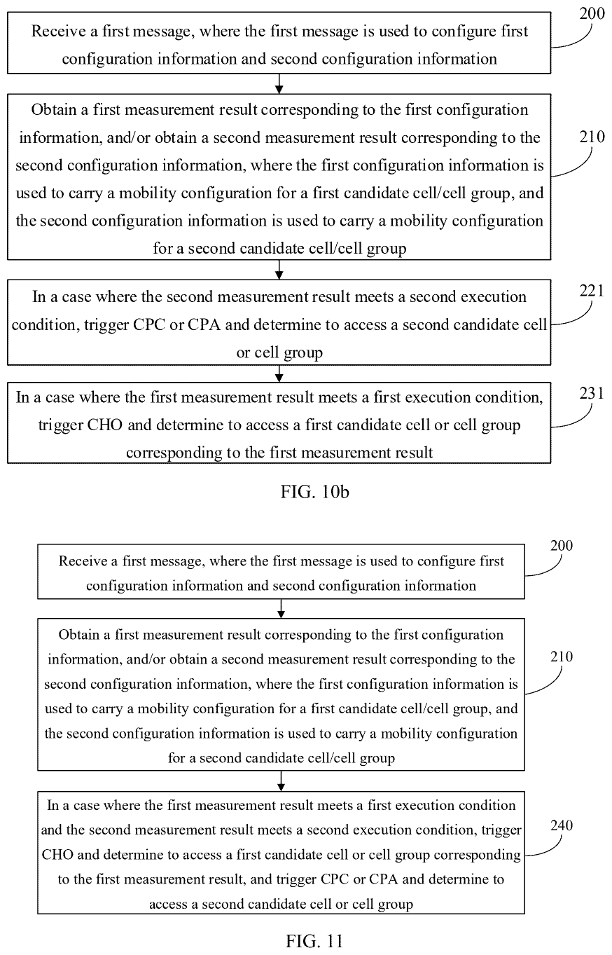

Referring to FIG. 10a, a flowchart of a cell measurement method provided by an embodiment of the present disclosure is shown. This embodiment is illustrated by taking an example in which the method is applied to a terminal in the communication system shown in FIG. 1. Based on the embodiments shown in FIG. 5a, step 210 further includes step 220 and step 230.

In step 200, a first message is received. The first message is used to configure first configuration information and second configuration information.

In step 210, a first measurement result corresponding to the first configuration information is obtained, and/or a second measurement result corresponding to the second configuration information is obtain. The first configuration information is used to carry a mobility configuration for a first candidate cell or cell group, and the second configuration information is used to carry a mobility configuration for a second candidate cell or cell group.

In step 220, in a case where the first measurement result meets a first execution condition, CHO is triggered, and it is determined to access a first candidate cell or cell group corresponding to the first measurement result.

For example, the terminal obtains a first execution condition according to a first measurement identity in the first configuration information, and determines whether the first measurement result meets the first execution condition. If the first measurement result meets the first execution condition, CHO is triggered and it is determined to access the first candidate cell or cell group (PCell or MCG); if the first measurement result does not meet the first execution condition, CHO is not triggered, and the terminal may continue to determine whether the second measurement result meets a second execution condition, or may not determine whether the second measurement result meets the second execution condition.

In an optional embodiment, the second candidate cell or cell group is a PSCell or SCG corresponding to the first candidate cell or cell group. In this case, when the terminal does not access the first candidate cell or cell group, the terminal does not first access the second candidate cell or cell group. That is, when the terminal determines not to access the first candidate cell or cell group, even if the second measurement result meets the second execution condition, the terminal does not access the second candidate cell or cell group.

For example, when the number of first measurement identities in the first configuration information is n, the number of measurement results included in the first measurement result is also n. The terminal obtains n measurement results corresponding to the n first measurement identities respectively and n execution conditions corresponding to the n first measurement identities respectively. When each of the n measurement results meets its corresponding execution condition (an i-th measurement result corresponding to an i-th first measurement identity meets an i-th execution condition corresponding to the i-th first measurement identity), it is determined that the first measurement result meets the first execution condition, and configuration information for the first candidate cell or cell group corresponding to the first configuration identity is applied to access the first candidate cell or cell group, where n is a positive integer and i is a positive integer not greater than n.

For example, if one measurement result among the multiple measurement results does not meet a corresponding execution condition, it is determined that the first measurement result does not meet the first execution condition, and CHO is not triggered.

For example, the first configuration information includes three first measurement identities: a first measurement identity a, a first measurement identity b, and a first measurement identity c. The first measurement identity a corresponds to a measurement result a and an execution condition a. The first measurement identity b corresponds to a measurement result b and an execution condition b. The first measurement identity c corresponds to a measurement result c and an execution condition c. In this case, the first measurement result includes the measurement result a, the measurement result b and the measurement result c, and the first execution condition includes the execution condition a, the execution condition b and the execution condition c. When the measurement result a meets the execution condition a, and the measurement result b meets the execution condition b, and the measurement result c meets the execution condition c, it is determined that the first measurement result meets the first execution condition. When the measurement result a does not meet the execution condition a, or the measurement result b does not meet the execution condition b, or the measurement result c does not meet the execution condition c, it is determined that the first measurement result does not meet the first execution condition.

For example, in a case where the first measurement result meets the first execution condition, a request for accessing the first candidate cell or cell group is sent according to configuration information for the first candidate cell or cell group.

In step 230, in a case where the second measurement result meets the second execution condition, CPC or CPA is triggered and it is determined to access a second candidate cell or cell group.

For example, the terminal obtains a second execution condition according to a second measurement identity in the second configuration information, and determines whether the second measurement result meets the second execution condition. If the second measurement result meets the second execution condition, CPC or CPA is triggered and it is determined to access the second candidate cell or cell group (PSCell or SCG); if the second measurement result does not meet the second execution condition, CPC or CPA is not triggered.

For example, when the number of second measurement identities in the second configuration information is n, the number of measurement results included in the second measurement result is also n. The terminal obtains n measurement results corresponding to the n second measurement identities respectively and n execution conditions corresponding to the n second measurement identities respectively. When each of the n measurement results meets its corresponding execution condition (an i-th measurement result corresponding to an i-th second measurement identity meets an i-th execution condition corresponding to the i-th second measurement identity), it is determined that the second measurement result meets the second execution condition, and the configuration information for the second candidate cell or cell group corresponding to the second configuration identity is applied to access the second candidate cell or cell group, where n is a positive integer and i is a positive integer not greater than n.

For example, if one of the multiple measurement results does not meet the corresponding execution condition, it is determined that the second measurement result does not meet the second execution condition, and the CPAC is not triggered.

For example, the second configuration information includes three second measurement identities: a second measurement identity d, a second measurement identity e, and a second measurement identity f. The second measurement identity d corresponds to a measurement result d and an execution condition d. The second measurement identity e corresponds to a measurement result e and an execution condition e. The second measurement identity f corresponds to a measurement result f and an execution condition f. In this case, the second measurement result includes the measurement result d, the measurement result e, and the measurement result f. The second execution condition includes the execution condition d, the execution condition e, and the execution condition f. When the measurement result d meets the execution condition d, and the measurement result e meets the execution condition e, and the measurement result f meets the execution condition f, it is determined that the second measurement result meets the second execution condition. When the measurement result d does not meet the execution condition d, or the measurement result e does not meet the execution condition e, or the measurement result f does not meet the execution condition f, it is determined that the second measurement result does not meet the second execution condition.

In an optional embodiment, whether the first measurement result meets the first execution condition is first determined, thereby triggering CHO, and then in a case where the first measurement result meets the first execution condition, whether the second measurement result meets the second execution condition is further determined. If the second measurement result meets the second execution condition, CPA or CPC is triggered, and if the second measurement result does not meet the second execution condition, CPA or CPC is not triggered.

For example, in response to a first measurement result for a first candidate cell or cell group indicated in a first RRCReconfiguration in a first condRRCReconfig meeting a first execution condition, the UE applies the first condRRCReconfig. The UE evaluates whether a second measurement result of a second candidate cell or cell group indicated in a second RRCReconfiguration in a second condRRCReconfig meets a second execution condition based on a second measurement result for a second measurement identity indicated by the second execution condition, and in response to the second execution condition being met, the UE applies the second condRRCReconfig.

The UE applies the first condRRCReconfig, that is, the UE triggers CHO and accesses a candidate PCell or MCG (the first candidate cell or cell group). The UE applies the second condRRCReconfig, that is, the UE triggers CPA or CPC and accesses a candidate PSCell or SCG (the second candidate cell or cell group). The first candidate cell or cell group is associated with the second candidate cell or cell group.

For example, when the terminal has accessed a PSCell or SCG, the terminal triggers CPC to switch the accessed PSCell or SCG. When the terminal has not accessed a PSCell or SCG, the terminal triggers CPA to access the second candidate PSCell or SCG.

For example, when the first measurement result meets the first execution condition and the second measurement result meets the second execution condition, a request for accessing the second candidate cell or cell group is sent according to configuration information for the second candidate cell or cell group.

In view of the above, in the technical solutions provided in the embodiments, after the terminal obtains the first measurement result and the second measurement result according to the first measurement identity and the second measurement identity, the terminal can first determine whether the first measurement result meets the first execution condition. If the first measurement result meets the first execution condition, the terminal accesses the first candidate cell or cell group. Then, the terminal determines whether the second measurement result meets the second execution condition. If the second measurement result meets the second execution condition, the terminal accesses the second candidate cell or cell group. Thus, the technical solutions can improve the cell access or cell switching efficiency of the terminal.

For example, there is provided another example embodiment in which a terminal performs CHO evaluation according to a first measurement result and performs CPAC evaluation according to a second measurement result.

Referring to FIG. 10b, a flowchart of a cell measurement method provided by an embodiment of the present disclosure is shown. This embodiment is illustrated by taking an example in which the method is applied to a terminal in the communication system shown in FIG. 1. Based on the embodiments shown in FIG. 5a, step 221 and step 231 are further included after step 210.

In step 200, a first message is received. The first message is used to configure first configuration information and second configuration information.

In step 210, a first measurement result corresponding to the first configuration information is obtained, and/or a second measurement result corresponding to the second configuration information is obtained. The first configuration information is used to carry a mobility configuration for a first candidate cell or cell group, and the second configuration information is used to carry a mobility configuration for a second candidate cell or cell group.

In step 221, in a case where the second measurement result meets a second execution condition, CPC or CPA is triggered and it is determined to access a second candidate cell or cell group.

For example, based on the relevant description of the embodiments shown in FIG. 10a, the terminal may also first determine whether the second measurement result meets the second execution condition, and then perform step 231 to determine whether the first measurement result meets the first execution condition.

For example, the order in which the terminal determines whether two measurement results meet their execution conditions may be arbitrary, but the order for performing cell access based on the determination results is certain: the first candidate cell or cell group needs to be accessed before the second candidate cell or cell group is accessed; if the terminal does not access the first candidate cell or cell group, the second candidate cell or cell group will definitely not be accessed; if the terminal accesses the first candidate cell or cell group, the second candidate cell or cell group may not be accessed.

In step 231, in a case where the first measurement result meets the first execution condition, CHO is triggered and it is determined to access a first candidate cell or cell group corresponding to the first measurement result.

For example, the relevant description in the embodiments shown in FIG. 10a is also applicable to the embodiments shown in FIG. 10b.

For example, in a case where the first measurement result meets the first execution condition and the second measurement result meets the second execution condition, the terminal may first access the first candidate cell or cell group, and then access the second candidate cell or cell group; or, the terminal may access the first candidate cell or cell group and not access the second candidate cell or cell group; or, the terminal may not access the first candidate cell or cell group, and not access the second candidate cell or cell group.

For example, in a case where the first measurement result meets the first execution condition and the second measurement result does not meet the second execution condition, the terminal may access the first candidate cell or cell group and not access the second candidate cell or cell group; or, the terminal may not access the first candidate cell or cell group and not access the second candidate cell or cell group.

For example, in a case where the first measurement result does not meet the first execution condition and the second measurement result does not meet the second execution condition, the terminal does not access the first candidate cell or cell group, and does not access the second candidate cell or cell group.

For example, in a case where the first measurement result does not meet the first execution condition but the second measurement result meets the second execution condition, the terminal does not access the first candidate cell or cell group, and does not access the second candidate cell or cell group.

In view of the above, in the technical solutions provided in the embodiments, after the terminal obtains the first measurement result and the second measurement result according to the first measurement identity and the second measurement identity, the terminal can first determine whether the second measurement result meets the second execution condition, and then determine whether the first measurement result meets the first execution condition, and then access the first candidate cell or cell group or the second candidate cell or cell group based on the two determination results. Thus, the technical solutions can improve the cell access or cell switching efficiency of the terminal.

For example, there is provided another example embodiment in which a terminal performs CHO evaluation according to a first measurement result and performs CPAC evaluation according to a second measurement result.

Referring to FIG. 11, a flowchart of a cell measurement method provided by an embodiment of the present disclosure is shown. This embodiment is illustrated by taking an example in which the method is applied to a terminal in the communication system shown in FIG. 1. Based on the embodiments shown in FIG. 5a, step 240 is further included after step 210.

In step 210, in a case where first configuration information includes second configuration information, a first measurement result corresponding to the first measurement identity is obtained, and/or a second measurement result corresponding to the second measurement identity is obtained. The first configuration information carries a first measurement identity, and the second configuration information carries a second measurement identity.

In step 240, in a case where the first measurement result meets a first execution condition and the second measurement result meets a second execution condition, CHO is triggered to access a first candidate cell or cell group corresponding to the first measurement result, and CPC or CPA is triggered to access a second candidate cell or cell group.

For example, the terminal determines whether the first measurement result meets the first execution condition, and determines whether the second measurement result meets the second execution condition. If both the first and second measurement results meet their executions, the terminal applies the configuration information for the first candidate cell or cell group (PCell or MCG) and the second candidate cell or cell group (PCell or MCG), and triggers CHO and CPAC to access the first candidate cell or cell group and the second candidate cell or cell group.

For example, in a case where the first measurement result meets the first execution condition but the second measurement result does not meet the second execution condition, the terminal does not trigger CHO and CPAC, does not access the first candidate cell or cell group, and does not access the second candidate cell or cell group.

For example, in a case where the first measurement result does not meet the first execution condition but the second measurement result meets the second execution condition, the terminal does not trigger CHO and CPAC, does not access the first candidate cell or cell group, and does not access the second candidate cell or cell group.

For example, in a case where the first measurement result does not meet the first execution condition and the second measurement result does not meet the second execution condition, the terminal does not trigger CHO and CPAC, does not access the first candidate cell or cell group, and does not access the second candidate cell or cell group.

For example, when the number of first measurement identities in the first configuration information is n, n first measurement results corresponding to the n first measurement identities respectively and n execution conditions corresponding to the n first measurement identities respectively are obtained. When each measurement result of the n first measurement results meets its corresponding execution condition (an i-th first measurement result corresponding to an i-th first measurement identity meets an i-th execution condition corresponding to the i-th first measurement identity), it is determined that the first measurement result meets the first execution condition, where n is a positive integer and i is a positive integer not greater than n.

For example, if one first measurement result among the multiple first measurement results does not meet a corresponding execution condition, it is determined that the first measurement result does not meet the first execution condition.

For example, when the number of second measurement identities in the second configuration information is n, n second measurement results corresponding to the n second measurement identities respectively and n execution conditions corresponding to the n second measurement identities respectively are obtained. When each of the n second measurement results meets its corresponding execution condition (an i-th measurement result corresponding to an i-th second measurement identity meets an i-th execution condition corresponding to the i-th second measurement identity), it is determined that the second measurement result meets the second execution condition, where n is a positive integer and i is a positive integer not greater than n.

For example, if one second measurement result among the multiple second measurement results does not meet a corresponding execution condition, it is determined that the second measurement result does not meet the second execution condition.

In an optional embodiment, the terminal simultaneously determines whether the first measurement result and the second measurement result meet their execution conditions, and only when both measurement results meet the execution conditions, the terminal will simultaneously access the associated first candidate cell or cell group and the second candidate cell or cell group. If any one of the measurement results does not meet its execution condition, the terminal does not access the first candidate cell or cell group and the second candidate cell or cell group.

For example, in response to a measurement result for a first cell or first cell group indicated in a first RRCReconfiguration in a first condRRCReconfig meeting a first execution condition and a measurement result for a second cell or second cell group indicated in a second RRCReconfiguration in a second condRRCReconfig meeting a second execution condition, the UE applies the first condRRCReconfig and the second condRRCReconfig.

The UE applies the first condRRCReconfig, that is, the UE triggers CHO and accesses a candidate PCell or MCG (the first candidate cell or cell group). The UE applies the second condRRCReconfig, that is, the UE triggers CPA or CPC and accesses a candidate PSCell or SCG (the second candidate cell or cell group). The first candidate cell or cell group is associated with the second candidate cell or cell group.

For example, in a case where the first measurement result meets the first execution condition and the second measurement result meets the second execution condition, a request for accessing the first candidate cell or cell group is sent according to the configuration information for the first candidate cell or cell group, and a request for accessing the second candidate cell or cell group is sent according to the configuration information for the second candidate cell or cell group.

In view of the above, in the technical solutions provided in the embodiments, after the terminal obtains the first measurement result and the second measurement result according to the first measurement identity and the second measurement identity, the terminal can simultaneously determine whether the first measurement result meets the first execution condition and whether the second measurement result meets the second execution condition. If both the first and second measurement results meets their execution conditions, the terminal accesses the first candidate cell or cell group and the second candidate cell or cell group; if one of the measurement results does not meet its corresponding execution condition, the terminal does not access the first candidate cell or cell group and the second candidate cell or cell group. Thus, the technical solutions can improve the cell access or cell switching efficiency of the terminal.

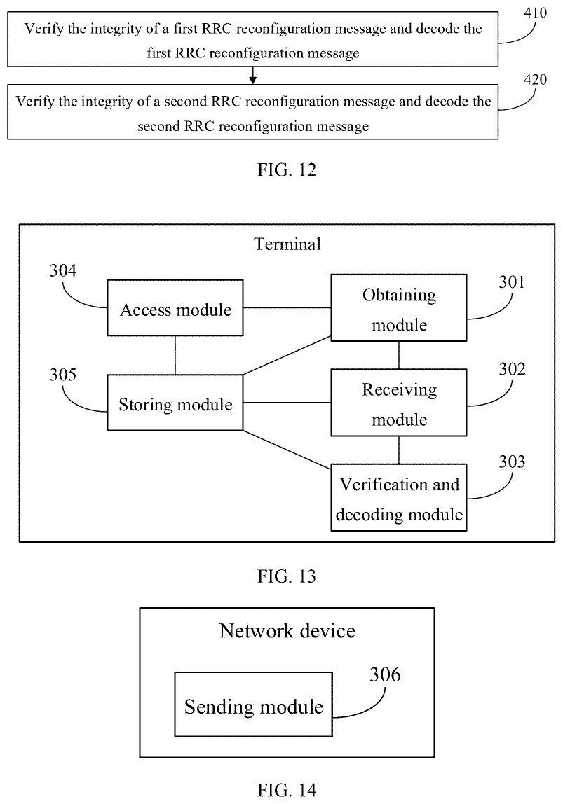

Referring to FIG. 12, a flowchart of a cell measurement method provided by an embodiment of the present disclosure is shown. This embodiment is illustrated by taking an example in which the method is applied to a terminal in the communication system shown in FIG. 1. Based on the embodiments shown in FIG. 5a, step 410 and step 420 may further be included after step 200 and before step 210.

In step 410, the integrity of a first RRC reconfiguration message is verified and the first RRC reconfiguration message is decoded. Optionally, when the terminal receives the first configuration information, the terminal verifies the integrity of the first RRC reconfiguration message; and/or; decodes the first RRC reconfiguration message to obtain configuration information for a first candidate cell or cell group and second configuration information. The configuration information for the first candidate cell or cell group and the second configuration information are stored in a variable conditional reconfiguration.

For example, the integrity check and decoding of the RRCReconfiguration received as part of the ConditionalReconfiguration is performed when the message is received. That is, when the UE receives the first configuration information, the UE needs to decode the configuration information for the candidate cell or cell group included therein (i.e., the first RRCReconfiguration) to determine whether a candidate target cell configuration corresponding to first conditional reconfiguration configuration information includes second conditional reconfiguration configuration information and an execution condition corresponding to the second conditional reconfiguration configuration information. Subsequently, measurement(s) and evaluation(s) can be started.

In step 420, the integrity of a second RRC reconfiguration message is verified and the second RRC reconfiguration message is decoded.

Optionally, when the terminal receives the first configuration information, the terminal verifies the integrity of the second RRC reconfiguration message and decodes it; or, when the second measurement result meets the second execution condition, the terminal verifies the integrity of the second RRC reconfiguration message and decodes it.

For example, the integrity check and decoding of the second RRCReconfiguration message included in the second configuration information may be performed when the message is received, or when the second execution condition is met and SCG mobility is performed, which may depend on the UE implementation. For example, when the second measurement result meets the second execution condition, the terminal verifies the integrity of the second RRC reconfiguration message and decodes it, and performs CPAC according to the configuration information for the second candidate cell or cell group obtained by decoding.

In view of the above, in the technical solutions provided by the embodiments, when the terminal receives the first configuration information, the terminal can verify the integrity of the first RRC reconfiguration message and the second RRC reconfiguration message and perform decoding; the terminal can also verify the integrity of the second RRC reconfiguration message and perform decoding when the second measurement result meets the second execution condition.

In an optional embodiment, the terminal receives first conditional reconfiguration configuration information (first configuration information) sent by the network side, and the first conditional reconfiguration configuration information is used to configure a mobility of an MCG and a mobility of an SCG (the SCG is associated with the MCG), for example, configuration information for configuring CHO and CPA or CPC.

In an optional embodiment, the first conditional reconfiguration configuration information includes one or more pieces of second conditional reconfiguration configuration information (second configuration information), where the second conditional reconfiguration configuration information is used to configure the mobility of the SCG.

In an optional embodiment, the first conditional reconfiguration configuration information includes a first configuration identity (condReconfigId), a first execution condition (condExecutionCond) corresponding to the MCG mobility (CHO), and a first RRCReconfiguration (a first RRC reconfiguration) message (carried in a first condRRCReconfig field) that needs to be applied when the first execution condition is met.

In an optional embodiment, the first RRCReconfiguration message includes one or more pieces of second conditional reconfiguration configuration information, and the first RRCReconfiguration message further includes configuration information for a candidate PCell or MCG. The configuration information for the candidate PCell or MCG is used for accessing the candidate PCell or MCG.

In an optional embodiment, the second conditional reconfiguration configuration information includes: a second configuration identity, a second execution condition (condExecutionCond or condExecutionCondSCG) corresponding to the SCG mobility (CPA or CPC), and a second RRCReconfiguration message (carried in a second condRRCReconfig field) that needs to be applied when the second execution condition is met. The second RRCReconfiguration message further includes configuration information for a candidate SPCell or SCG.

In an optional embodiment, the first execution condition and the second execution condition may be represented by measurement identities.

In an optional embodiment, in response to receiving one or more pieces of first conditional reconfiguration configuration information, the UE stores the configuration information and stores the configuration information in VarConditionalReconfig for storing conditional reconfiguration configuration information.

In an optional embodiment, the UE starts relevant measurements based on the measurement identities, and obtains measurement results corresponding to the measurement identities indicated by the first execution condition and the second execution condition.

In an optional embodiment, for measurement identities with an associated report type as conditional trigger, if there are execution conditions (condExecutionCond or condExecutionCondSCG) configured by the network indicating these measurement identities, the UE initiates corresponding measurements, regardless of whether the measurement configurations corresponding to these execution conditions are directly or indirectly stored in VarConditionalReconfig.

In an optional embodiment, for a measurement identity stored in the UE, if the report type in an associated report configuration is conditional trigger (condTriggerConfig) and the measurement identity is indicated by a first execution condition corresponding to a first configuration identity in VarConditionalReconfig, if the UE meets other condition(s) related to obtaining of the measurement result, the UE obtains the measurement result corresponding to the measurement identity.

In an optional embodiment, other condition(s) related to obtaining of the measurement results include(s), but not limited to, one or more of the following:
1. if a measurement gap configuration is setup, or
2. if the UE does not require measurement gaps to perform the concerned measurements (if the terminal does not require a measurement gap when performing the measurement)
3. if s-MeasureConfig is not configured, or (the first measurement configuration (s-MeasureConfig) is not configured, where the first measurement configuration is used to measure the quality of the serving cell, or)
4. if s-MeasureConfig is set to ssb-RSRP and the NR SpCell RSRP based on SS or PBCH block, after layer 3 filtering, is lower than ssb-RSRP, or (the first measurement configuration is configured as a first SSB-RSRP, and a second SSB-RSRP of the sPCell after layer 3 filtering is lower than the first SSB-RSRP, or)
5. if s-MeasureConfig is set to csi-RSRP and the NR SpCell RSRP based on CSI-RS, after layer 3 filtering, is lower than csi-RSRP (the first measurement configuration is configured as a first CSI-RSRP, and a second CSI-RSRP of sPCell after layer 3 filtering is lower than the first SCI-RSRP).

In an optional embodiment, for a measurement identity stored in the UE, if the report type in an associated report configuration is conditional trigger and the measurement identity is indicated by a second execution condition, where the second execution condition is an execution condition corresponding to a second conditional reconfiguration identity (a second configuration identity) included in second conditional reconfiguration configuration information included in a first condRRCReconfig corresponding to a first conditional reconfiguration identity (first configuration identity) in VarConditionalReconfig, if the UE meets other condition(s) related to obtaining of the measurement result, the UE obtains the measurement result corresponding to the measurement identity.

In an optional embodiment, the UE evaluates whether the first execution condition and the second execution condition are met based on the measurement results corresponding to the first execution condition and the second execution condition. In response to the measurement result for the first candidate cell or cell group indicated in the first RRCReconfiguration in the first condRRCReconfig meeting the first execution condition, the UE applies the first condRRCReconfig. The UE evaluates whether the measurement result for the second candidate cell or cell group indicated in the second RRCReconfiguration in the second condRRCReconfig meets the second execution condition based on the measurement result for a measurement identity indicated by the second execution condition. In response to the second execution condition being met, the UE applies the second condRRCReconfig.

In an optional embodiment, the UE applies the first condRRCReconfig, that is, the UE triggers CHO and accesses a candidate MCG (the first candidate cell or cell group). The UE applies the second condRRCReconfig, that is, the UE triggers CPA or CPC and accesses a candidate SCG (the second candidate cell or cell group). The first candidate cell or cell group is associated with the second candidate cell or cell group.

In an optional embodiment, the UE evaluates whether the first execution condition and the second execution condition are met based on the measurement results corresponding to the first execution condition and the second execution condition. In response to the measurement result for the first cell or first cell group indicated in the first RRCReconfiguration in the first condRRCReconfig meeting the first execution condition and the measurement result for the second cell or the second cell group indicated in the second RRCReconfiguration in the second condRRCReconfig meeting the second execution condition, the UE applies the first condRRCReconfig and the second condRRCReconfig.

In an optional embodiment, the integrity check and decoding of the RRCReconfiguration received as part of the ConditionalReconfiguration is performed when the message is received. That is, when the UE receives the first conditional reconfiguration configuration information, the UE needs to decode the first RRCReconfiguration included therein to determine whether the first RRCReconfiguration corresponding to the first conditional reconfiguration configuration information includes the second conditional reconfiguration configuration information, and the second execution condition corresponding to the second conditional reconfiguration configuration information, so as to facilitate the subsequent initiation of measurements and evaluations.

In an optional embodiment, the integrity check and decoding of the second RRCReconfiguration message included in the second conditional reconfiguration configuration information may be performed when the message is received, or may be performed when the second execution condition is met and SCG mobility is performed, depending on the UE implementation.

In an optional embodiment, in response to the first conditional reconfiguration configuration information being used for the mobility of the MCG, the second conditional reconfiguration configuration information included in the first conditional reconfiguration configuration information can only be used for the mobility of the SCG but cannot be used for the mobility of the MCG.

In an optional embodiment, in response to the first conditional reconfiguration configuration information being used for the mobility of the SCG, the first conditional reconfiguration configuration information cannot include conditional reconfiguration configuration information.

It should be noted that the above embodiments in the present application may be combined with other embodiments, steps in other embodiments, or specific steps of the steps in other embodiments, if such combination will not result in contradiction. In addition, the sequence of the method steps provided in the embodiments of the present application may be appropriately adjusted, and the steps may be increased or decreased accordingly according to the situations. Any person of ordinary skill in this art can easily think of changes to the methods within the technical scope disclosed in the present application, and the changes should be included in the protection scope of the present application, and repeated descriptions will be omitted here.

The following describes apparatus embodiments of the present disclosure, which may be used to perform the method embodiments of the present disclosure. For details not disclosed in the apparatus embodiments of the present disclosure, reference may be made to the method embodiments of the present disclosure.

Referring to FIG. 13, a block diagram of a cell measurement apparatus provided by an embodiment of the present disclosure is shown. The apparatus has the functions of implementing the above-described method examples at the terminal side. The functions may be implemented by hardware, or by hardware executing corresponding software. The apparatus may be the terminal described above, or the apparatus may be set in the terminal. The apparatus may include a receiving module 302 and an obtaining module 301.

The receiving module 302 is configured to receive a first message. The first message is used to configure first configuration information and second configuration information.

The obtaining module 301 is configured to obtain a first measurement result corresponding to the first configuration information, and/or obtain a second measurement result corresponding to the second configuration information;

where the first configuration information is used to carry a mobility configuration for a first candidate cell or cell group, and the second configuration information is used to carry a mobility configuration for a second candidate cell or cell group.

In an optional embodiment, the first configuration information carries the second configuration information.

In an optional embodiment, the first configuration information includes a first execution condition, and the first execution condition is used for determination of accessing the first candidate cell or cell group.

In an optional embodiment, the first configuration information includes a first measurement identity, and the first measurement identity is used to indicate the first execution condition.

In an optional embodiment, the second configuration information includes a second execution condition, and the second execution condition is used for determination of accessing the second candidate cell or cell group.

In an optional embodiment, the second configuration information includes a second measurement identity, and the second measurement identity is used to indicate the second execution condition.

In an optional embodiment, the apparatus further includes a storing module 305 configured to:
store the first configuration information in a variable conditional reconfiguration VarConditionalReconfig.

In an optional embodiment, the first configuration information includes a first execution condition, and the second configuration information includes a second execution condition;
the obtaining module 301 is configured to obtain the first measurement result corresponding to a first measurement identity in a case where a report type associated with the first measurement identity is conditional trigger and the first measurement identity is indicated in the first execution condition;
and/or, the obtaining module 301 is configured to obtain the second measurement result corresponding to a second measurement identity in a case where a report type associated with the second measurement identity is the conditional trigger and the second measurement identity is indicated in the second execution condition.

In an optional embodiment, the first configuration information includes a first execution condition, and the second configuration information includes a second execution condition;
where a report type associated with a first measurement identity is conditional trigger, and the first measurement identity is indicated in the first execution condition;
and/or, where the report type associated with a second measurement identity is the conditional trigger, and the second measurement identity is indicated in the second execution condition.

In an optional embodiment, the first configuration information includes a first execution condition, a first configuration identity and a first conditional RRC reconfiguration, and the second configuration information includes a second execution condition and a second configuration identity;
the obtaining module 301 is configured to obtain the first measurement result corresponding to a first measurement identity in a case where a report type associated with the first measurement identity is conditional trigger, and the first measurement identity is indicated in the first execution condition, and the first execution condition is associated with the first configuration identity in a variable conditional reconfiguration;
and/or, the obtaining module 301 is configured to obtain the second measurement result corresponding to a second measurement identity in a case where a report type associated with the second measurement identity is the conditional trigger, and the second measurement identity is indicated in the second execution condition, and the second execution condition is associated with the second configuration identity, and the second configuration identity is included in the first conditional RRC reconfiguration;
where the first conditional RRC reconfiguration is included in the variable conditional reconfiguration.

In an optional embodiment, the first configuration information includes a first execution condition, a first configuration identity and a first conditional RRC reconfiguration, and the second configuration information includes a second execution condition and a second configuration identity;
where a report type associated with a first measurement identity is conditional trigger, the first measurement identity is indicated in the first execution condition, and the first execution condition is associated with the first configuration identity in a variable conditional reconfiguration;
and/or, where a report type associated with a second measurement identity is the conditional trigger, the second measurement identity is indicated in the second execution condition, the second execution condition is associated with the second configuration identity, the second configuration identity is included in the first conditional RRC reconfiguration, and the first conditional RRC reconfiguration is included in the variable conditional reconfiguration.

In an optional embodiment, the first configuration information includes a first execution condition, a first configuration identity and a first conditional RRC reconfiguration, and the second configuration information includes a second execution condition and a second configuration identity;
the obtaining module 301 is configured to obtain the first measurement result corresponding to a first measurement identity in a case where a report type associated with the first measurement identity is conditional trigger, and the first measurement identity is indicated in the first execution condition, and the first execution condition is associated with the first configuration identity in a variable conditional reconfiguration;
and/or, the obtaining module 301 is configured to obtain the second measurement result corresponding to a second measurement identity in a case where a report type associated with the second measurement identity is the conditional trigger, and the second measurement identity is indicated in the second execution condition, and the second execution condition is an execution condition corresponding to the second configuration identity in the first conditional RRC reconfiguration corresponding to the first configuration identity in the variable conditional reconfiguration.

In an optional embodiment, the first configuration information includes a first execution condition, a first configuration identity and a first conditional RRC reconfiguration, and the second configuration information includes a second execution condition and a second configuration identity;
where a report type associated with a first measurement identity is conditional trigger, the first measurement identity is indicated in the first execution condition, and the first execution condition is associated with the first configuration identity in a variable conditional reconfiguration;
and/or, a report type associated with a second measurement identity is the conditional trigger, the second measurement identity is indicated in the second execution condition, and the second execution condition is an execution condition corresponding to the second configuration identity in the first conditional RRC reconfiguration corresponding to the first configuration identity in the variable conditional reconfiguration.

In an optional embodiment, in a case where the first candidate cell or cell group includes a candidate primary cell or Master Cell Group (MCG), the second candidate cell or cell group includes a candidate primary secondary cell or Secondary Cell Group (SCG); or, in a case where the first candidate cell or cell group includes a first candidate primary cell or MCG, the second candidate cell or cell group includes a second candidate primary cell or MCG.

In an optional embodiment, the first configuration information includes configuration information for Conditional Handover (CHO) for the first candidate cell or cell group, and the second configuration information includes configuration information for Conditional Primary secondary cell Change (CPC) and/or Conditional Primary secondary cell Addition (CPA) for the second candidate cell or cell group.

In an optional embodiment, the first configuration information includes a first execution condition, and configuration information for the first candidate cell or cell group; the apparatus further includes an access module 304 configured to:
in a case where the first measurement result meets the first execution condition, trigger CHO and determine to access the first candidate cell or cell group corresponding to the first measurement result.

In an optional embodiment, the second configuration information includes a second execution condition, and configuration information for the second candidate cell or cell group; the apparatus further includes an access module 304 configured to:
in a case where the second measurement result meets the second execution condition, triggering CPC or CPA, and determining to access the second candidate cell or cell group.

In an optional embodiment, the first configuration information includes a first execution condition, and configuration information for the first candidate cell or cell group;
where the second configuration information includes a second execution condition, and configuration information for the second candidate cell or cell group;
the apparatus further includes an access module 304 configured to: in a case where the first measurement result meets the first execution condition and the second measurement result meets the second execution condition, trigger CHO and determine to access the first candidate cell or cell group corresponding to the first measurement result, and trigger CPC or CPA and determine to access the second candidate cell or cell group.

In an optional embodiment, the first candidate cell or cell group is associated with the second candidate cell or cell group; the apparatus further includes an access module 304 configured to: access the first candidate cell or cell group; and/or, access the second candidate cell or cell group in a case where the first candidate cell or cell group is accessed.

In an optional embodiment, the first configuration information includes a first RRC reconfiguration message, and the first RRC reconfiguration message includes configuration information for the first candidate cell or cell group and the second configuration information; the apparatus further includes a verification and decoding module 303 configured to: when the first configuration information is received, verify integrity of the first RRC reconfiguration message;
and/or,
the verification and decoding module 303 is configured to decode the first RRC reconfiguration message to obtain the configuration information for the first candidate cell or cell group and the second configuration information.

In an optional embodiment, the first configuration information includes the first RRC reconfiguration message, the first RRC reconfiguration message includes the second configuration information, and the second configuration information includes a second execution condition and a second RRC reconfiguration message;
the apparatus further includes a verification and decoding module 303 configured to: when the first configuration information is received, verify integrity of the second RRC reconfiguration message and decode the second RRC reconfiguration message;
or, the verification and decoding module is configured to, in a case where the second measurement result meets the second execution condition, verify the integrity of the second RRC reconfiguration message and decode the second RRC reconfiguration message.

For example, the apparatus is configured to perform the steps performed by the terminal in the method according to any one of the embodiments described above, and the explanations and illustrations in the above method embodiments are also applicable to the apparatus.

Referring to FIG. 14, a block diagram of a cell measurement apparatus provided by an embodiment of the present disclosure is shown. The apparatus has the functions of implementing the above-described method examples at the network device side. The functions may be implemented by hardware, or by hardware executing corresponding software. The apparatus may be the network device described above, or the apparatus may be set in the network device. The apparatus may include a sending module 306 configured to:
send a first message, where the first message is used to configure first configuration information and second configuration information;
where the first configuration information is used to configure a mobility configuration for a first candidate cell or cell group for a terminal, and the second configuration information is used to configure a mobility configuration for a second candidate cell or cell group for the terminal.

In an optional embodiment, the first configuration information carries the second configuration information.

In an optional embodiment, the first configuration information includes a first execution condition, and the first execution condition is used for determination of accessing the first candidate cell or cell group.

In an optional embodiment, the first configuration information includes a first measurement identity, and the first measurement identity is used to indicate the first execution condition.

In an optional embodiment, the second configuration information includes a second execution condition, and the second execution condition is used for determination of accessing the second candidate cell or cell group.

In an optional embodiment, the second configuration information includes a second measurement identity, and the second measurement identity is used to indicate the second execution condition.

In an optional embodiment, the first configuration information includes a first execution condition, and the second configuration information includes a second execution condition;
where a report type associated with a first measurement identity is conditional trigger, and the first measurement identity is indicated in the first execution condition;
and/or, where a report type associated with a second measurement identity is the conditional trigger, and the second measurement identity is indicated in the second execution condition.

In an optional embodiment, the first configuration information includes a first execution condition, a first configuration identity and a first conditional RRC reconfiguration, and the second configuration information includes a second execution condition and a second configuration identity;
where a report type associated with a first measurement identity is conditional trigger, the first measurement identity is indicated in the first execution condition, and the first execution condition is associated with the first configuration identity in a variable conditional reconfiguration;
and/or, where a report type associated with a second measurement identity is the conditional trigger, the second measurement identity is indicated in the second execution condition, the second execution condition is associated with the second configuration identity, the second configuration identity is included in the first conditional RRC reconfiguration, and the first conditional RRC reconfiguration is included in the variable conditional reconfiguration.

In an optional embodiment, the first configuration information includes a first execution condition, a first configuration identity and a first conditional RRC reconfiguration, and the second configuration information includes a second execution condition and a second configuration identity;
where a report type associated with a first measurement identity is conditional trigger, the first measurement identity is indicated in the first execution condition, and the first execution condition is associated with the first configuration identity in a variable conditional reconfiguration;
and/or, where a report type associated with a second measurement identity is the conditional trigger, the second measurement identity is indicated in the second execution condition, and the second execution condition is an execution condition corresponding to the second configuration identity in the first conditional RRC reconfiguration corresponding to the first configuration identity in the variable conditional reconfiguration.

In an optional embodiment, in a case where the first candidate cell or cell group includes a candidate primary cell or Master Cell Group (MCG), the second candidate cell or cell group includes a candidate primary secondary cell or Secondary Cell Group (SCG); or in a case where the first candidate cell or cell group includes a first candidate primary cell or MCG, the second candidate cell or cell group includes a second candidate primary cell or MCG.

In an optional embodiment, the first configuration information includes configuration information for Conditional Handover (CHO) for the first candidate cell or cell group, and the second configuration information includes configuration information for Conditional Primary secondary cell Change (CPC) and/or Conditional Primary secondary cell Addition (CPA) for the second candidate cell or cell group.

For example, the apparatus is configured to perform the steps performed by the network device in the method according to any one of the embodiments described above, and the explanations and illustrations in the above method embodiments are also applicable to the apparatus.

It should be noted that regarding the apparatuses in the above embodiments, when the apparatuses implement their functions, the division of the above-mentioned functional modules is merely an example. In actual applications, the above-mentioned functions may be assigned to different functional modules according to actual needs, that is, the content structure of the apparatuses may be divided into different functional modules to complete all or part of the functions described above.

Regarding the apparatuses in the above embodiments, the specific manner in which each module performs operations has been described in detail in the embodiments of the methods, and repeated descriptions will be omitted here.

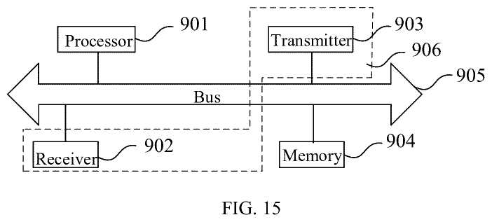

Referring to FIG. 15, a schematic diagram of a structure of a communication device (a terminal or a network device) provided by an embodiment of the present disclosure is shown. The communication device may include: a processor 901, a receiver 902, a transmitter 903, a memory 904 and a bus 905.

The processor 901 includes one or more processing cores. The processor 901 executes various functional applications and performs cell measurement by running software programs and modules.

The receiver 902 and the transmitter 903 may be implemented as a transceiver 906, which may be a communication chip.

The memory 904 is connected to the processor 901 via the bus 905.

The memory 904 may be configured to store a computer program, and the processor 901 may be configured to execute the computer program to implement respective steps performed by the communication device in the above method embodiments.

In addition, the memory 904 may be implemented by any type of volatile or non-volatile storage device or a combination thereof. The volatile or non-volatile storage device includes but is not limited to: a Random-Access Memory (RAM) and a Read-Only Memory (ROM), an Erasable Programmable Read-Only Memory (EPROM), an Electrically Erasable Programmable Read-Only Memory (EEPROM), a flash memory or other solid-state storage technology, a Compact Disc Read-Only Memory (CD-ROM), a Digital Video Disc (DVD) or other optical storage, a tape cassette, a magnetic tape, a magnetic disk storage or other magnetic storage device.

When the communication device is implemented as a terminal, the processor 901 involved in the embodiments of the present disclosure may perform the steps performed by the terminal in the method shown in any of the above embodiments, and the explanations and illustrations in the above method embodiments are also applicable to the communication device and repeated description will be omitted here.

In a possible implementation, when the communication device is implemented as a terminal:
the transceiver is configured to receive a first message, where the first message is used to configure first configuration information and second configuration information;
the processor is configured to: obtain a first measurement result corresponding to the first configuration information, and/or obtain a second measurement result corresponding to the second configuration information;
the first configuration information is used to carry a mobility configuration for a first candidate cell or cell group, and the second configuration information is used to carry a mobility configuration for a second candidate cell or cell group.

In a possible implementation, when the communication device is implemented as a network device:
the transceiver is configured to send a first message, where the first message is used to configure first configuration information and second configuration information;
the first configuration information is used to configure a mobility configuration for a first candidate cell or a cell group of a terminal, and the second configuration information is used to configure a mobility configuration for a second candidate cell or a cell group of the terminal.

An embodiment of the present disclosure further provides a cell measurement system. The system includes:
a network device configured to send a first message, where the first message is used to configure first configuration information and second configuration information; and
a terminal configured to receive the first message;
where the terminal is configured to: obtain a first measurement result corresponding to the first configuration information, and/or obtain a second measurement result corresponding to the second configuration information;
where the first configuration information is used to carry a mobility configuration for a first candidate cell or cell group, and the second configuration information is used to carry a mobility configuration for a second candidate cell or cell group.

For example, the terminal is further configured to perform the cell measurement method at the terminal side provided in any one of the above embodiments.

For example, the network device is further configured to perform the cell measurement method at the network device side provided in any of the above embodiments.

An embodiment of the present disclosure further provides a computer-readable storage medium. A computer program is stored in the storage medium. The computer program is configured to be executed by a processor of a terminal to implement the cell measurement method(s) at the terminal side. For example, the computer program is configured to be executed by a terminal or a network device to implement the steps in the method(s) in any one of the above embodiments, and the explanations and illustrations in the above method embodiments are also applicable to the computer program.

Optionally, the computer readable storage medium may include: a Read-Only Memory (ROM), a Random Access Memory (RAM), Solid State Drives (SSD) or an optical disk, etc. The random access memory may include a Resistance Random Access Memory (ReRAM) and a Dynamic Random Access Memory (DRAM).

An embodiment of the present disclosure further provides a chip. The chip includes a programmable logic circuit and/or program instructions. When the chip is run on a terminal, the cell measurement method(s) at the terminal side is (are) implemented. For example, the chip is configured to implement the steps performed by the terminal or network device in the method in any one of the above embodiments, and the illustrations and explanations in the above method embodiments are also applicable to the chip.

An embodiment of the present disclosure further provides a computer program product or a computer program. The computer program product or the computer program includes computer instructions, and the computer instructions are stored in a computer-readable storage medium. A processor of a terminal reads and executes the computer instructions from the computer-readable storage medium to implement the cell measurement method(s) at the terminal side or the network device side. For example, the computer program product or the computer program is configured to be executed by the terminal to implement the steps in the method in any of the above embodiments, and the illustrations and explanations in the above method embodiments are also applicable to the computer program product or the computer program.

The technical solutions provided by the embodiments of the present disclosure can bring the following beneficial effects:
when configuration information for two kinds of cell measurements is jointly configured, for example, the first configuration information and the second configuration information are configured in the first message, and measurement identity (identities) exists (exist) in the first configuration information and the second configuration information, the terminal can obtain corresponding measurement result(s) according to the measurement identity (identities) in the first configuration information, and can also obtain the corresponding measurement result(s) according to the measurement identity (identities) in the second configuration information, thereby improving the cell measurement efficiency of the terminal.

It should be understood that the “indication” mentioned in embodiments of the present disclosure may be a direct indication, an indirect indication, or may indicate that there is an association relationship. For example, A indicates B, which can mean: A directly indicates B, for example, B may be obtained through A; it can also mean: A indirectly indicates B, for example, A indicates C, and B may be obtained through C; it can also mean: there is an association relationship between A and B.

The term “correspondence” in embodiments of the present disclosure may indicate a direct or indirect correspondence between two objects, or an association between the two objects, or a relationship of indicating and being indicated, configuring and being configured, etc.

The term “multiple” as used herein refers to two or more than two. The expression “and/or” describes an association relationship between associated objects, indicating that three relationships may exist. For example, A and/or B can mean: A exists alone, A and B exist at the same time, and B exists alone. The character “/” generally indicates that the related objects before and after the character are in an “or” relationship.

In addition, the step numbers described herein only illustrate a possible execution order between the steps. In some other embodiments, the above steps may not be executed in the order of the numbers. For example, two steps with different numbers are executed at the same time, or two steps with different numbers are executed in the opposite order to that shown in the figures. The embodiments of the present disclosure do not impose limitations on this.

Those skilled in the art should be aware that in one or more of the above examples, the functions described in the embodiments of the present disclosure may be implemented with hardware, software, firmware, or any combination thereof. When implemented using software, these functions may be stored in a computer-readable medium or transmitted as one or more instructions or codes on a computer-readable medium. The computer-readable medium includes a computer storage medium and a communication medium. The communication medium includes any medium that facilitates the transmission of a computer program from one place to another. The storage medium may be any available medium that a general or special-purpose computer can access.

The above description shows only example embodiments of the present disclosure and is not intended to limit the present disclosure. Any modifications, equivalent substitutions, improvements, etc. made within the spirit and principles of the present disclosure should fall within the protection scope of the present disclosure.

1. A cell measurement method, wherein the method is performed by a terminal, and the method comprises:
receiving a first message, wherein the first message is used to configure first configuration information and second configuration information; and
obtaining a first measurement result corresponding to the first configuration information, and/or obtaining a second measurement result corresponding to the second configuration information;
wherein the first configuration information is used to carry a mobility configuration for a first candidate cell or cell group, and the second configuration information is used to carry a mobility configuration for a second candidate cell or cell group, and
the first candidate cell or cell group comprises a candidate primary cell or master cell group (MCG), and the second candidate cell or cell group comprises a candidate primary secondary cell or secondary cell group (SCG).

2. (canceled)

3. The method according to claim 1, wherein the first configuration information comprises a first execution condition, and the first execution condition is used for determining access to the first candidate cell or cell group, and
the second configuration information comprises a second execution condition, and the second execution condition is used for determining access to the second candidate cell or cell group.

4.-6. (canceled)

7. The method according to claim 1, further comprising:
storing the first configuration information in a variable conditional reconfiguration (VarConditionalReconfig).

8. The method according to claim 1, wherein the first configuration information comprises a first execution condition, and the second configuration information comprises a second execution condition;
wherein obtaining the first measurement result corresponding to the first configuration information, and obtaining the second measurement result corresponding to the second configuration information, comprises:
obtaining the first measurement result corresponding to a first measurement identity, wherein a report type associated with the first measurement identity is conditional trigger, and the first measurement identity is indicated in the first execution condition;
and
obtaining the second measurement result corresponding to a second measurement identity, wherein a report type associated with the second measurement identity is the conditional trigger, and the second measurement identity is indicated in the second execution condition.

9. The method according to claim 1, wherein the first configuration information comprises a first execution condition, and the second configuration information comprises a second execution condition;
wherein a report type associated with a first measurement identity is conditional trigger, and the first measurement identity is indicated in the first execution condition;
and/or
wherein a report type associated with a second measurement identity is the conditional trigger, and the second measurement identity is indicated in the second execution condition.

10. The method according to claim 1, wherein the first configuration information comprises a first execution condition, a first configuration identity and a first conditional RRC reconfiguration, and the second configuration information comprises a second execution condition and a second configuration identity;
wherein obtaining the first measurement result corresponding to the first configuration information, and/or obtaining the second measurement result corresponding to the second configuration information, comprises:
obtaining the first measurement result corresponding to a first measurement identity, wherein a report type associated with the first measurement identity is conditional trigger, the first measurement identity is indicated in the first execution condition, and the first execution condition is associated with the first configuration identity in a variable conditional reconfiguration;
and
obtaining the second measurement result corresponding to a second measurement identity, wherein a report type associated with the second measurement identity is the conditional trigger, the second measurement identity is indicated in the second execution condition, the second execution condition is associated with the second configuration identity, and the second configuration identity is comprised in the first conditional RRC reconfiguration;
wherein the first conditional RRC reconfiguration is comprised in the variable conditional reconfiguration.

11. The method according to claim 1, wherein the first configuration information comprises a first execution condition, a first configuration identity and a first conditional RRC reconfiguration, and the second configuration information comprises a second execution condition and a second configuration identity;
wherein a report type associated with a first measurement identity is conditional trigger, the first measurement identity is indicated in the first execution condition, and the first execution condition is associated with the first configuration identity in a variable conditional reconfiguration;
and/or
wherein a report type associated with a second measurement identity is the conditional trigger, the second measurement identity is indicated in the second execution condition, the second execution condition is associated with the second configuration identity, the second configuration identity is comprised in the first conditional RRC reconfiguration, and the first conditional RRC reconfiguration is comprised in the variable conditional reconfiguration.

12. The method according to claim 1, wherein the first configuration information comprises a first execution condition, a first configuration identity and a first conditional RRC reconfiguration, and the second configuration information comprises a second execution condition and a second configuration identity;
wherein obtaining the first measurement result corresponding to the first configuration information, and/or obtaining the second measurement result corresponding to the second configuration information, comprises:
obtaining the first measurement result corresponding to a first measurement identity, where a report type associated with the first measurement identity is conditional trigger, the first measurement identity is indicated in the first execution condition, and the first execution condition is associated with the first configuration identity in a variable conditional reconfiguration;
and
obtaining the second measurement result corresponding to a second measurement identity, wherein a report type associated with the second measurement identity is the conditional trigger, the second measurement identity is indicated in the second execution condition, and the second execution condition is an execution condition corresponding to the second configuration identity in the first conditional RRC reconfiguration corresponding to the first configuration identity in the variable conditional reconfiguration.

13. The method according to claim 1, wherein the first configuration information comprises a first execution condition, a first configuration identity and a first conditional RRC reconfiguration, and the second configuration information comprises a second execution condition and a second configuration identity;
wherein a report type associated with a first measurement identity is conditional trigger, the first measurement identity is indicated in the first execution condition, and the first execution condition is associated with the first configuration identity in a variable conditional reconfiguration;
and/or
wherein a report type associated with a second measurement identity is the conditional trigger, the second measurement identity is indicated in the second execution condition, and the second execution condition is an execution condition corresponding to the second configuration identity in the first conditional RRC reconfiguration corresponding to the first configuration identity in the variable conditional reconfiguration.

14.-17. (canceled)

18. The method according to claim 1, wherein the first configuration information comprises a first execution condition, and configuration information for the first candidate cell or cell group;
wherein the second configuration information comprises a second execution condition, and configuration information for the second candidate cell or cell group;
wherein the method further comprises:
in a case that the first measurement result meets the first execution condition and the second measurement result meets the second execution condition, triggering CHO and determining to access the first candidate cell or cell group corresponding to the first measurement result, and triggering CPC or CPA and determining to access the second candidate cell or cell group.

19.-21. (canceled)

22. A cell measurement method, wherein the method is performed by a network device, and the method comprises:
sending a first message, wherein the first message is used to configure first configuration information and second configuration information;
wherein the first configuration information is used to configure a mobility configuration for a first candidate cell or cell group for a terminal, and the second configuration information is used to configure a mobility configuration for a second candidate cell or cell group for the terminal, and
the first candidate cell or cell group comprises a candidate primary cell or master cell group (MCG), and the second candidate cell or cell group comprises a candidate primary secondary cell or secondary cell group (SCG).

23. The method according to claim 22, wherein the first configuration information comprises a first execution condition, and the second configuration information comprises a second execution condition;
wherein a report type associated with a first measurement identity is conditional trigger, and the first measurement identity is indicated in the first execution condition;
and/or
wherein a report type associated with a second measurement identity is the conditional trigger, and the second measurement identity is indicated in the second execution condition.

24. The method according to claim 22, wherein the first configuration information comprises a first execution condition, a first configuration identity and a first conditional RRC reconfiguration, and the second configuration information comprises a second execution condition and a second configuration identity;
wherein a report type associated with a first measurement identity is conditional trigger, the first measurement identity is indicated in the first execution condition, and the first execution condition is associated with the first configuration identity in a variable conditional reconfiguration;
and
wherein a report type associated with a second measurement identity is the conditional trigger, the second measurement identity is indicated in the second execution condition, the second execution condition is associated with the second configuration identity, the second configuration identity is comprised in the first conditional RRC reconfiguration, and the first conditional RRC reconfiguration is comprised in the variable conditional reconfiguration.

25. The method according to claim 22, wherein the first configuration information comprises a first execution condition, a first configuration identity and a first conditional RRC reconfiguration, and the second configuration information comprises a second execution condition and a second configuration identity;
wherein a report type associated with a first measurement identity is conditional trigger, the first measurement identity is indicated in the first execution condition, and the first execution condition is associated with the first configuration identity in a variable conditional reconfiguration;
and
wherein a report type associated with a second measurement identity is the conditional trigger, the second measurement identity is indicated in the second execution condition, and the second execution condition is an execution condition corresponding to the second configuration identity in the first conditional RRC reconfiguration corresponding to the first configuration identity in the variable conditional reconfiguration.

26.-30. (canceled)

31. A terminal, comprising a transceiver and a processor;
wherein the transceiver is configured to receive a first message, wherein the first message is used to configure first configuration information and second configuration information;
wherein the processor is configured to obtain a first measurement result corresponding to the first configuration information, and/or obtain a second measurement result corresponding to the second configuration information;
wherein the first configuration information is used to carry a mobility configuration for a first candidate cell or cell group, and the second configuration information is used to carry a mobility configuration for a second candidate cell or cell group, and
the first candidate cell or cell group comprises a candidate primary cell or master cell group (MCG), and the second candidate cell or cell group comprises a candidate primary secondary cell or secondary cell group (SCG).

32. A network device, comprising a transceiver;
wherein the transceiver is configured to perform the cell measurement method according to claim 22.

33. (canceled)

34. A non-transitory computer-readable storage medium, wherein a computer program is stored in the storage medium, and the computer program is used to be executed by a processor to implement the cell measurement method according to claim 1.

35. A chip, wherein the chip comprises a programmable logic circuit and/or a program instruction, and when the chip is run, the cell measurement method according to claim 1 is implemented.

36. The terminal according to claim 31, wherein the first configuration information comprises a first execution condition, and the first execution condition is used for determining access to the first candidate cell or cell group, and
the second configuration information comprises a second execution condition, and the second execution condition is used for determining access to the second candidate cell or cell group.

37. The terminal according to claim 31, wherein the processor is further configured to store the first configuration information in a variable conditional reconfiguration (VarConditionalReconfig).
